(19) United States
(12) Patent Application Publication
(10) Pub. No.: US 2004/0248028 A1
(43) Pub. Date: Dec. 9, 2004

(54) Electrophotographic image forming process and electrophotographic image receiving material

(76) Inventors: Shigehisa Tamagawa, Shizuoka (JP); Yoshio Tani, Shizuoka (JP); Shinji Kato, Shizuoka (JP)

Correspondence Address: YOUNG & THOMPSON, 745 SOUTH 23RD STREET, 2ND FLOOR, ARLINGTON, VA, 22202, US

(21) Appl. No.: 10/809,500

(22) Filed: Mar. 26, 2004

(30) Foreign Application Priority Data
May 2, 2003 (JP) 2003-127152

(51) Int. Cl. G03G 13/20

(52) U.S. Cl. 430/124

(57) ABSTRACT

An electrophotographic image receiving sheet comprising a support and a toner image receiving layer formed on the support and a process of forming an image on the sheet are disclosed. The support comprises base paper that contains more than 0.5 g/m² of at least one of an alkali metal salt and an alkaline earth metal salt and a moisture content of 6.5% by weight or more and a polyolefin resin layer formed on each surface of the base paper. The base paper preferably contains the salt in a range of from 0.6 to 3 g/m² and a moisture content in a range of from 6.5 to 8.5% by weight.

### BACKGROUND OF THE INVENTION

1. Field of the Invention

The present invention relates to an electrographic image receiving material that forms a satisfactory image and has a good feeding property for electrophotographic printers and an image forming process for use with the electrophotographic image receiving material.

2. Description of Related Art

Conventionally, in order to produce a high quality image with electrophotography like with silver halide photography, resin coated supports such as a polyolefin resin double coated support are used as a support of an electrophotographic image receiving sheet. As disclosed in, for example, Japanese Unexamined Patent Publication Nos. 8-211645, 2000-0325 and 2000-0327, such a resin coated support provides an electrophotographic image receiving sheet having high smoothness, high glossiness and high flatness and excels at image quality and handling. On the other hand, the electrophotographic image receiving sheet is demanded to have a stable feeding property so as to avoid misfeeding such as jamming or double feeding with downsizing and speeding up of printing machines. In order to satisfy the demand, various electrophotographic image receiving sheets that are provided with antistatic layers and have improved surface smoothness, stiffness and/or curling property are known, for example, from Japanese Unexamined Patent Publication.Nos. 8-211645, 2000-0325, 2000-0327, 2001-138626 and 2001-228646.

However, none of the prior art electrophotographic image receiving sheets has satisfactory image quality and feeding property simultaneously, and it is the current situation that there is still a strong demand for an electrophotographic image receiving sheet with satisfactory characteristics.

### SUMMARY OF THE INVENTION

It is therefore an object of the present invention to provide an electrophotographic image receiving sheet that provides satisfactory image quality and has stable feeding property free from an occurrence of jamming and double feed.

It is another object of the present invention to provide an image forming process of forming a high quality image on an electrophotographic image receiving sheet.

The above objects of the present invention are accomplished by an electrophotographic image receiving sheet comprising a support and a toner image receiving layer formed on at least one surface of the support. The support comprises base paper that contains more than 0.5 g/m² of at least one of an alkali salt and an alkaline earth metal salt and a moisture content of 6.5% by weight or more, and a polyolefin resin layer formed on each surface of the base paper and an image forming process of forming an image on the electrophotographic image receiving sheet.

The base paper forming the electrophotographic image receiving sheet preferably contains the salt in a range of from 0.6 to 3 g/m² and a moisture content in a range of from 6.5 to 8.5% by weight. The salt may comprise at least one selected from a group of chloride of alkali metal, a carbonate of alkali metal, a sulfate of alkali metal, chloride of alkaline earth metal, a carbonate of alkaline earth metal and a sulfate of alkaline earth metal.

The base paper may further contain a water soluble high molecular compound in a range of from 0.5 to 3 g/m². The water soluble high molecular compound may comprise at least one selected from a group of polyvinyl alcohol, carboxy-modified polyvinyl alcohol, carboxymethyl cellulose, hydroxyethyl cellulose, cellulose sulfate, polyethylene oxides and gelatin.

The base paper is preferably prepared through surface sizing with solution containing at least either an alkali metal salt or an alkaline earth metal salt, and a water soluble high molecular compound and subsequently calendaring. The calender process is preferably performed with a soft calender with a metal roller at a surface temperature of 150° C. or higher.

The base paper may contain a sizing agent comprising at least one of an alkylketene dimer and an epoxidized fatty acid amide. The base paper contains pulp fibers preferably have a weight-average fiber length in a range of from 0.45 to 0.70 mm.

The image forming process comprising the steps of forming a toner image on the toner image receiving layer of the electrophotographic image receiving sheet, heating and pressing the toner image receiving layer between a fixing roller and a fixing belt, cooling the toner image receiving layer, and removing the electrophotographic image receiving sheet from the fixing belt. The image forming process may further comprise the step of fixing the toner image on the toner imager receiving layer with a heat roller before the heating and pressing of the toner image receiving layer with the fixing roller and the fixing belt.

The heating and pressing of the toner image receiving layer is performed preferably by use of a fixing belt having either one of a layer of fluorocarbon siloxane rubber and a layer comprising an under layer of silicone rubber and an over layer of fluorocarbon siloxane rubber. The fluorocarbon siloxane rubber comprises one having at least one of a perfluoroalkyl ether group and a perfluoroalkyl group in a principal chain.

According to the electrophotographic image receiving sheet of the present invention that comprises the support comprising base paper that contains more than 0.5 g/m² of at least one of an alkali metal salt and an alkaline earth metal salt and a moisture content of 6.5% by weight or more, and a polyolefin resin layer formed on each surface of the base paper, the electrophotographic image receiving sheet makes it reality to provide satisfactory image quality and stable feeding property free from an occurrence of jamming and double feed.

According to the image forming process of the present invention that comprises the steps of forming a toner image on the toner image receiving layer of the electrophotographic image receiving sheet, heating and pressing the toner image receiving layer between a fixing roller and a fixing belt, cooling the toner image receiving layer, and removing the electrophotographic image receiving sheet from the fixing belt, even though an oilless type electrophotographic machine that has no need of fixing oil is used, it is possible to feed the electrophotographic image receiving sheets stably free from offset of a toner image to the fixing roller and/or the fixing belt and to form an image of photographic quality.

### BRIEF DESCRIPTION OF THE DRAWINGS

The foregoing and other objects and features of the present invention will be clearly understood from the following detailed description when read with reference to the accompanying drawings, in which:

FIG. 1 is a schematic view of an electrophotographic machine for implementing the image forming process of the present invention; and

FIG. 2 is a schematic side view of a cooling and releasing belt fixing type smoothing device installed as fixing means in the electrophotographic machine of FIG. 1.

### DETAILED DESCRIPTION OF THE PREFERRED EMBODIMENTS

An electrophotographic image receiving sheet of the present invention comprises a support and at least one toner image receiving layer coated on the support and may comprise, if desired, additional layers including a surface protective layer, an intermediate layer, an undercoating layer, a cushioning layer, an electrostatic charge adjusting or antistatic layer, a reflective layer, a color tinge adjusting layer, a storage stability or quality improvement layer, anti-curling layer, a smoothing layer, etc. Each of these layers may have a single layer structure or a multi-layered structure. The support of the electrophotographic image receiving sheet is made up of base paper coated with a polyolefin resin layer on both surfaces. The paper support contains at least 0.5 g/m² of a salt of at least either one of alkali metal and alkane earth metal and 6.5% or more of water.

The salt of alkali metal or alkaline earth metal contained in the paper support preferably comprises at least one selected from a group of chloride salts, carbonates and sulfate salts of alkali metal and chloride salts, carbonates and sulfate salts of alkaline earth metal which include CaCl₂, CaCO₃, NaCl, Na₂CO₃, KCl, Na₂SO₄, K₂SO₄, and LiCl. The content of the salt of alkali metal or alkaline earth metal is preferably 0.5 μm² or more, and more preferably in a range of from 0.6 to 3 g/m². It is preferred to deposit the salt of alkali metal or alkaline earth metal on the paper support together with a water-soluble high-molecular compound by means of surface sizing which will be described later. If the content of the salt of alkali metal or alkaline earth metal is less than 0.5 g/m², the electrophotographic image receiving sheet often results in a defective feeding property due to development of static electricity. The paper support containing the salt of alkaline metal or alkaline earth metal further contains water, the water content being preferably 6.5% or more, and more preferably in a range of from 0.5 to 3 g/m². If the water content is less than 6.5%, the electrophotographic image receiving sheet often results in a defective feeding property due to development of static electricity.

The amount of water in the paper support of the electrophotographic image receiving sheet is estimated as a decrease in weight before and after dehydration of the base paper with the polyolefin resin layer peeled off at both interfaces at 105° C. for four hours.

[Support]

As was previously described, the support comprises base paper coated with a polyolefin resin layer oh both surfaces and, in necessary, other layers.

Base Paper

Base papers preferably used for the electrophotographic image receiving sheet includes, but not limited to, paper enumerated in “Fundamentals of Photographic Engineering-Silver Halide Photography-” pages 223-240, edited by Japanese Society of Photograph (published 1979 by Corona Co., Ltd.). Various raw materials can be selectively used for the base paper (including synthetic paper) as appropriate. These raw materials include, but not limited to, for example, natural pulp such as softwood or coniferous tree pulp or hardwood or broad leaf tree pulp, synthetic pulp made of a plastic material such as polyethylene or polypropylene, and mixtures of natural pulp and synthetic pulp. It is preferred to use bleached broad leaf tree kraft pulp (LBKP) as a row material of the base paper in light of improving surface smoothness, stiffness and dimensional stability (curling property) all together to a sufficient and balanced level. It is allowed to use bleached coniferous tree kraft pulp (NBKP) or broad leaf sulphite pulp (LBSP) as a row material of the base paper. Fibers of these pulp are preferred to have a weight-average fiber length in a range of from 0.45 to 0.70 mm.

A beater or a refiner can be used to beat the pulp fibers. A pulp slurry (which is referred to as pulp paper stuff in some cases) attained by beating is allowed to be added various additives, e.g. a loading material, a dry paper strength enhancing agent, a sizing agent, a wet paper strength enhancing agent, a fixing agent, a pH adjuster and other chemical conditioners or agents as appropriate. The degree of whiteness of the pulp paper stuff defined by JIS P8123 is preferably 88% or higher and more preferably 90% or higher. If the degree of whiteness is less than 88%, the pulp stuff is apt to be tinged strikingly yellow and, it becomes hard in some cases to adjusted whiteness with a fluorescent brightening agent or a bluing agent.

Preferable examples of the loading material include calcium carbonate, clay, kaolin, a white earth, talc, a titanium oxide, a diatom earth, barium sulfate, an aluminum hydroxide, a magnesium hydroxide, etc.

Preferable examples of the dry paper strength enhancing agent include cationic starch, cationic polyacrylamide, anionic polyacrylamide, amphoteric polyacrylamide, carboxy-modified polyvinyl alcohol, etc.

Preferable examples of the sizing agent include a fatty acid salt, rosin, a rosin derivative such as maleic rosin, paraffin wax, an alkylketene dimer, an alkenyl anhydrate succinic acid (ASA), an epoxidized fatty acid amide, etc. Among them, an alkylketene dimmer or an epoxidized fatty acid amide is preferable.

Preferable examples of the wet paper strength enhancing agent include polyamine polyamide epichlorohydrin, a melamine resin, a urea resin, an epoxidized polyamide resin, etc.

Preferable examples of the fixing agent include a polyvalent metal salt such as aluminum sulfate or aluminum chloride, a cationic polymer such as cationic starch, etc.

Preferable examples of the pH adjuster include caustic soda, sodium carbonate, etc.

Materials that may be added as a chemical additive to the pulp slurry include, for example, a deforming agent, dye, a slime controlling agent, etc. In addition, it is allowed to use, if necessary, softening agents such as described in “New Handbook For Paper Processing” pages 554 and 555 (1980 Edition by Paper Chemicals Times).

The base paper is processed for surface sizing by a size press machine. A sizing solution for use with the surface sizing contains a metal salt of at least either salts of alkali metal or salts of alkaline earth metal, a water-soluble polymeric compound, a fluorescent brightening agent, a water resistant material, a pigment, a dye, etc.

Preferable examples of the water-soluble polymeric compound include, but not limited to, polyvinyl alcohol, carboxy-modified polyvinyl alcohol, carboxymethyl cellulose, hydroxyethyl cellulose, cellulose sulfate, polyethylene oxides, gelatin, cationic starch, casein, sodium polyacrylate, a sodium salt of styrene-maleic anhydrate copolymer, polystyrene sodium sulfonate, etc. Among them are polyvinyl alcohol, it is preferable to employ carboxy-modified polyvinyl alcohol, carboxymethyl cellulose, hydroxyethyl cellulose, cellulose sulfate, polyethylene oxides or gelatin, and particularly preferable to employ polyvinyl alcohol. The content of the water-soluble polymeric compound is preferably in a range of from 0.5 to 2 g/m².

Preferable examples of the fluorescent brightening agent includes stilbene compounds, coumarin compounds, biphenyl compounds, benzooxazoline compounds, naphthalimide compounds, pyrazoline compounds, carbostyryl compounds, diaminostilbene disulphonic acid derivatives, imidazole derivatives, coumarin derivatives, triazole derivatives, carbazole derivatives, pyridine derivatives, naphthionic acid derivatives, imidazolone derivatives, etc. The content of the fluorescent brightening agent is preferably in, but not limited to, a range of from 0.01 to 0.5% by weight, and more preferably in a range of from 0.02 to 0.2% by weight, of the base paper.

Preferable examples of the water resistant material includes latex emulsions such as styrene-butadiene copolymers, ethylene-vinyl acetate copolymers, polyethylene, vinylidene chloride copolymers or the like, polyamide polyamine epichlorohydrin, etc.

Preferable examples of the pigment includes calcium carbonates, clay, Kaolin, talc, barium sulfate, titanium oxides, etc.

It is preferable that the base paper described above has a Young's modulus ratio of longitudinal Young's modulus (Ea) relative to transversal Young's modulus (Eb) is in a range of from 1.5 to 2.0. If the Young's modulus ratio is out of the range, i.e. less than 1.5 or greater than 2.0, the electrophotographic image receiving sheet is apt to encounter aggravation of stiffness and/or curling property and, in consequence, to incur aggravation of feeding property.

The surface smoothness of the base paper at a toner image receiving side in Oken scale (which is a scale on the code of JAPAN TAPPI Rule No. 5 B) is preferably beyond 210 seconds and more preferably beyond 250 seconds. If the surface smoothness is less than 210 seconds, the quality of toner image is defective, so that it is undesirable to use the base paper for the electrophotographic image receiving sheet. The upper limit is preferably, but not limited to, approximately 600 seconds, and more preferably approximately 500 seconds, in actuality.

It has been known that “stiffness” of paper is different depending upon beating manners. Elastic force (elasticity) of paper made after beating can be employed as one of key factors representing the “stiffness” of paper. In particular, the elasticity of paper can be find by using the relationship between the dynamic modulus of elasticity representing a solid state property of paper as a visco-elastic body and the density of paper and measuring the acoustic propagation velocity through paper by an ultrasonic transducer and is expressed by the following equation.

E=ρc²(1−n²)

where E is the dynamic elastic coefficient;

ρ is the paper density;

c is the acoustic propagation velocity through paper

n is Poisson's ratio.

Because Poisson's ratio n of ordinary paper is approximately 0.2 at the highest, the dynamic modulus of elasticity can be approximated by the following equation.

E=ρc²

That is, the modulus of elasticity is easily obtained in the event where the density of paper and the acoustic propagation velocity of paper. An acoustic propagation velocity of paper can be measured by an instrument well known in the art such as, for example, Sonic Tester SST-110 (which is manufactured by Nomura Co., Ltd.).

The base paper preferably has a density higher than 0.9 g/cm³, more preferably higher than 0.95 g/cm³ and most preferably in a range of from 0.95 to 1.2 g/cm³. In addition, the base paper preferably has, but not limited to, a thickness in a range of from 30 to 500 μm, more preferably in a range of from 50 to 300 μm, and most preferably in a range of from 100 to 250 μm. It is also appropriate for the base paper to have, but not limited, a basic weight preferably in a range of from 50 to 250 g/m² and more preferably in a range of from 100 to 200 g/m².

Polyolefin Resin Layer

Polyolefin resins available for the polyolefin resin layer include, for example, a resin of α-olefin homopolymer such as polyethylene, polypropylene, etc. and a resin of a mixture of polyethylene, polypropylene, etc. The molecular weight of these polyolefin resins are ordinarily preferable in, but not limited to, a range of from 20,000 to 200,000 as long as they are suitable for extrusion coating.

Preferable examples of the polyethylene resin includes, but not limited to, high density polyethylene (HDPE), low density polyethylene (LDPE), linear low density polyethylene (L-LDPE), etc. For example, in light of uniform and neat cut section of a support when cutting the support to a specified dimension with a cutter in a cutting process, it is preferred to use a polyethylene resin mixture of 40 to 75 parts by weight of high density polyethylene having a melt index of from 5 to 30 g/10 min, preferably from 10 to 20 g/10 min and a density of higher than 0.945 g/m³ and 25 to 60 parts by weight of low density polyethylene having a melt index of from 1 to 15 g/10 min, preferably from 2 to 10 g/10 min and a density of less than 0.930 g/m³. These resins may be used independently or in a mixture of two or more of them. The mixture ratio by weight of high density polyethylene and low density polyethylene (HDPE/LDPE) is preferably between 40/60 and 75/25 and more preferably between 50/50 and 70/30. It is not improbable that the support does not have a desired cut feature (uniform cut section) in a cutting process when it is coated with a polyolefin resin layer of a mixture of more than 75 parts by weight of high density polyethylene and less than 25 parts by weight of low density polyethylene coated thereon. On the other hand, although the support has a desired cut feature in a cutting process when it is coated with a polyolefin resin layer of a mixture of less than 40 parts by weight of high density polyethylene and more than 60 parts by weight of low density polyethylene coated thereon, the support is undesirable because the sheet surfaces are possibly locally melted by heating rollers in a fixing process, this leads to an occurrence of jamming due to aggravation of surface quality or defective feeding property. In the case where the support is coated with polyolefin resin layer on opposite surfaces, it is preferred to apply the mixture composition to both polyolefin resin layers. The polyolefin resin layer may be added with a surface active agent and/or an antistatic agent such as a metal oxide or the like in order to adjust surface electric resistance and, further, may be used to double as a conductive layer containing these additives.

In light of providing a high quality image, the polyolefin resin layer when the support is coated with a single layer or at least one of the polyolefin resin layer when the support is coated with multiple layers may contain an inorganic pigment such as a titanium dioxide, a bluing agent, a fluorescent brightening agent, an antioxidant, etc. therein. Among them, it is particularly preferred for the polyolefin resin layer to contain a titanium dioxide. Further, in light of satisfactory adhesion properties to the base paper, when the support is coated with multiple layers, the bottom polyolefin resin layer in contact with the base paper may contain adhesion imparting resin, an adhesive resin, etc. therein. The polyolefin resin layer may further contain an antioxidant, a releasing agent, or a hollow polymer.

When letting the polyolefin resin layer contain titanium dioxides, the titanium dioxide may take, but not limited to, an anatase type or a rutile type. Strictly, the anatase type titanium dioxide is preferred in the case of giving priority to whiteness and the rutile type titanium dioxide is preferred in the case of giving priority to sharpness. Both types of titanium dioxides may be blended in the case of regarding both whiteness and sharpness. It is also allowed to use two polyolefin resin layers, one containing the anatase type titanium dioxide and the other containing the rutile type titanium dioxide.

The mean particle size of titanium dioxide particles is preferably in a range of from 0.1 to 0.4 μm. If the titanium oxide particles have a mean particle size less than 0.1 μm, it is hard to distribute the titanium oxide particles uniformly in the polyolefin resin layer. On the other hand, if the titanium oxide particles have a mean particle size beyond 0.4 μm, they are not only impossible to provide satisfactory whiteness but also cause tiny projections on the surface of the polyolefin resin layer. This results in poor image quality. It is preferred to apply a surface treatment to the titanium oxide particles with a silane coupling agent that is preferably modified at the end group by ethoxy or methoxy. The amount of the silane coupling agent used for the surface treatment is preferably in a range of from 0.05 to 2.5% by weight, more preferably in a range of from 0.5 to 2.0% by weight, with respect to the amount of titanium dioxide, If the amount of the silane coupling agent is less than 0.05% by weight, the silane coupling agent possibly can not be effective in surface treatment. On the other hand, if the amount of the silane coupling agent is beyond 2.5% by weight, the silane coupling agent has an effect on the titanium dioxide somewhat to excess. In order to restrain activity of the inorganic pigment of titanium dioxide as an inorganic pigment, it is preferred to apply a surface treatment to the titanium dioxide particles with an inorganic surface treatment agent that is preferable to be at least one of Al₂O₃ and SiO₂. The amount of the inorganic surface treatment agent (in an anhydrate form) used for the surface treatment is preferably in a range of from 0.01 to 1.8% by weight, more preferably in a range of from 0.2 to 1.0% by weight, with respect to the amount of titanium dioxide, If the titanium dioxide particles are not treated with the inorganic surface treatment agent, they are low in heat resistance and, in consequence, possibly turn yellow when used for extruded lamination at a temperature of approximately 320° C. In addition, because of no restraint of activity, the titanium dioxide particles are apt to agglutinate with the consequence that they get stuck with a metal filter screen of 20 to 400 meshes that is installed near an extrusion port of an extrusion machine for the purpose of containing a spill of foreign materials and, as a result, cause a rise in extrusion pressure in the extrusion machine. On the other hand, if the amount of the inorganic surface treatment agent is beyond 0.05% by weight, the inorganic surface treatment agent is apt to be clouded with condensation. The inorganic surface treatment agent clouded with condensation possibly hastens development of dirt retention on die lips of the extrusion machine for lamination.

The titanium dioxide is mixed and kneaded in the polyolefin resin together with an auxiliary dispersing agent such as a metal salt of high fatty acid, high fatty acid ethyl, high fatty acid amide, high fatty acid, polyolefin wax, etc. by a kneading machine such as a two-roll kneader, a three-roll kneader, a Banbury type mixer, a continuous kneading machine, etc. An example of the auxiliary dispersing agent is preferably a metal salt of stearic acid, and more preferably zinc stearic acid. The polyolefin resin kneaded with the inorganic pigment, i.e. titanium dioxide, is molded in the form of pellet and used as a mater batch of inorganic pigment. The concentration of titanium dioxide of a pellet is preferably in a range of from approximately 30 to approximately 75% by weight. The concentration of an auxiliary dispersing agent of the pellet is preferably in a range of from approximately 0.5 to 10% by weight. If the concentration of titanium dioxide is less than approximately 30% by weight, the pellet becomes somewhat bulky. On the other hand, if the concentration of titanium dioxide exceeds approximately 75% by weight, the titanium dioxide particles show deterioration in dispersibility and make the pellets easily crack. The master batch containing titanium dioxide is preferred to be dried at a temperature between 50 and 90° C. for longer than two hours with air drying or vacuum drying.

The titanium dioxide content of the polyolefin resin layer is preferably in a range of from 5 to 50% by weight and more preferably in a range of from 8 to 45% by weight. If the titanium dioxide content is less than 5% by weight, the electrophotographic image receiving sheet yields aggravation of resolution. On the other hand, if the titanium dioxide content exceeds 50% by weight, the polyolefin resin layer possibly develops die seams during formation.

Preferable examples of the bluing agent include an ultramarine blue pigment, a cobalt blue pigment, a phosphoric oxide cobalt blue pigment, a quinacridone pigment, etc. and mixtures of them. The particle size of bluing agent is preferably in, but not limited to, a range of from 0.3 to 10 μm by ordinary. In the case where the bluing agent is contained in a top layer of the multi-layered polyolefin resin layer, the content of bluing agent in the top layer is preferably in a range of from 0.2 to 0.4% by weight with respect to the weight of polyolefin resin of the top layer. On the other hand, in the case where the bluing agent is contained in a bottom layer of the multi-layered polyolefin resin layer, the content of bluing agent in the bottom layer is preferably in a range of from 0 to 0.15% by weight with respect to the weight of polyolefin resin of the bottom layer.

The antioxidant content of the polyolefin resin layer is preferably in a range of from 50 to 1000 ppm relative to the amount of the resin component. The mater batch containing the titanium dioxide pigment thus prepared is diluted with a resin forming a part of the polyolefin resin layer before extrusion lamination.

Preferable examples of the adhesion imparting resin includes, but not limited to, a resin of rosin derivative, a terpene resin such as high-molecular β-pinene, a coumarone-indene resin, a petroleum hydrocarbon resin, etc. These resins may be used individually or in any combination of two or more thereof.

Preferable examples of the petroleum hydrocarbon resin include aliphatic petroleum resins, aromatic petroleum resins, dichloropentadiene petroleum resins, copolymer petroleum resins, hydrogenated petroleum resins, alicyclic petroleum resins, etc. Among the aliphatic petroleum resins, it is preferred to employ one having five carbon atoms. Among the aromatic petroleum resins, it is preferred to employ one having nine carbon atoms. The compounding ratio of the adhesion imparting resin is preferably in a range of from 0.5 to 60% by weight by ordinary, and more preferably in a range of from 10 to 35% by weight, relative to the amount of a resin forming a part of the polyolefin resin layer. If the compounding ratio of the adhesion imparting resin is less than 0.5% by weight, the polyolefin resin layer possibly becomes defective in adhesion. On the other hand, If the compounding ratio of the adhesion imparting resin exceeds 60% by weight, the polyolefin resin layer possibly produces necking during formation.

Preferable examples of the adhesive resin include ionomer, ethylene vinyl acetate copolymers (EVA), ethylene-acryl copolymers, metal salts of them, etc. The compounding ratio of the adhesive resin is preferably in a range of from 20 to 500% by weight, and more preferably in a range of from 50 to 200% by weight, relative to the amount of a resin forming a part of the polyolefin resin layer. The adhesive resin may be used in combination with the adhesion imparting resin.

The polyolefin resin layer is formed by melting the titanium oxide contained pellets and diluting the molten pellets with a resin as one of the components of the polyolefin resin layer, if desired, and applying a coating of the molten material on the base paper by an ordinary lamination process, a sequential lamination process, or a lamination process using a laminator with a mono- or multi-layer extrusion die such as of a feet block type, a multi-manifold type, a multi-slot type. General examples of the mono- or multi-layer die include, but not limited in shape to, a T-shaped die, a coat hanger die, etc. It is preferred to apply a corona discharge treatment, a flame treatment, a glow discharge treatment or a plasma discharge treatment for surface activity before forming the polyolefin resin layer on the base paper.

The thickness of the polyolefin resin layer that is formed on the front surface of the support (the side where a toner image receiving layer is formed) is preferably in a range of from 10 to 60 μm. On the other hand, the thickness of the polyolefin resin layer that is formed on the back surface of the support is preferably in a range of from 10 to 50 μm. The top layer of the polyolefin resin layer on the front surface of the support is finished off with a textured finish to a glossy surface or a fine-grain surface, matted surface or a silk surface such as disclosed in Japanese Unexamined Patent Publication No. 55-26507. The top layer of the polyolefin resin layer on the back surface of the support is finished off with a textured finish to a mat surface. It may be performed to apply a surface activation treatment such as a corona discharge treatment, a flame treatment, etc. to the surfaces of the polyolefin resin layer after the a textured finish and further to apply a coating treatment after the activation treatment.

Toner Image Receiving Layer

The toner image receiving layer receives a color toner image or a black toner image. The toner image is transferred to the toner image receiving layer from a developing drum or an intermediate image transfer material with electrostatics or pressure in a transfer process and then fixed in a fixing process.

The toner image receiving layer is preferred to have a transparency less than 78%, preferably less than 73% and most preferably less than 72%, of light transmittance in light of providing a feel of a kind of photograph. The light transmittance can be obtained from measurements as to a sample toner image receiving layer that is the same in structure and thickness as the substantive toner image receiving layer but coated on a polyethylene terephthalate film (100 μm) measured by a direct reading Hayes meter (Suga Testing Machine HGM-2DP). A material for the toner image receiving layer contains at least a thermoplastic resin and, may be added with various additives such as a releasing agent, a plasticizer, a coloring agent, a filler, a cross-linking agent, an electrification controlling agent, an emulsifier, a dispersing agent, etc. for the purpose of improving the thermodynamic properties.

Thermoplastic Resin

The thermoplastic resin is not limited as long as it is transformable under a specific temperature condition in, for example, a fixing process. Preferable examples of the thermoplastic resin are resins cognate with a binder resin contained in a toner and preferably include copolymer resins of a polyester resin, styrene, styrene-butyl acrylate, etc. A resin containing more than 20% of a copolymer of a polyester resin, styrene or styrene-butyl acrylate are more preferable. Further preferable examples of the thermoplastic resin include styrene-acrylic ester copolymer, styrene-methacrylic ester copolymer. More specifically, it is preferred to employ as the thermoplastic resin (a) a resin having an ester bond or the like, (b) a polyurethane resin or the like, (c) a polyamide resin or the like, (d) a polysulfone resin or the like, (e) polyvinyl chloride resin or the like, (f) a polyvinyl butyral resin or the like, (g) a polycaprolactone resin or the like, or (h) a polyolefin resin or the like.

Preferable examples of (a) the resin having an ester bond include polyester resins obtained in the form of a condensation product of a dicarboxylic acid component (which may include a substituted sulfonic acid group or a substituted carboxyl group) such as a terephthalic acid, an isophthalic acid, a maleic acid, a fumaric acid, a phthalic acid, an adipic acid, a sebacic acid, an azelaic acid, an abietic acid, a succinic acid, a trimellitic acid, a pyromellitic acid, etc and an alcoholic component (which may include a substituted hydroxyl group) such as ethylene glycol, diethylene glycol, propylene glycol, bisphenol A, diether derivatives of bisphenol A, (for example, adducts of ethylene oxide, propylene oxide or both to bisphenol A), bisphenol S, 2-ethylecyclohexyldimethanol, neopentyl glycol, cyclohexyldirethanol, glycerin, etc.; polyacrylic ester resins or polymethacrylic ester resins such as polymethyl methacrylate, polybutyl methacrylate, polymethyl acrylate, polybutyl acrylate, etc.; polycarbonate resins; polyvinyl acetate resins; styrene acrylate resins; styrene-methacrylic acid ester copolymer resins; vinyltoluene acrylate resins; etc. More specifically, there are various examples disclosed in Japanese Unexamined Patent Publication Nos. 59(1984)-101359, 60(1985)-294862, 63(1988)-7971,63(1988)-7972, 63(1988)-7973.

Commercially available examples of the polyester resin include, but not limited to, Vyron 103, Vyron 200, Vyron 280, Vyron 300, Vyron GK-130 and Vyron GK-140 (which are manufactured by Toyobo Co., Ltd.); Tafuton NE-382, Tafuton U-5, Tafuton ATR-2009 and Tafuton ATR-2010 (which are manufactured by Kao Co., Ltd.); Elitel UE3500, Elitel UE3210, Elitel XA-8153, (which are manufactured by Unitika Ltd.); Polyester TP-220 and Polyester R-188 (which are manufactured by Nippon Synthetic Chemical Industry Co., Ltd.); etc. Commercially available examples of the acrylate resin include, but not limited to, Dianal SE-5437, Dianal SE-5102, Dianal SE-5377, Dianal SE-5649, Dianal SE-5466, Dianal SE-5482, Dianal HR-169, Dianal HR-124, Dianal HR-1127, Dianal HR-116, Dianal HR-113, Dianal HR-148, Dianal HR-131, Dianal HR470, Dianal HR-634, Dianal HR-606, Dianal HR-607, Dianal LR-1065, Dianal LR-574, Dianal LR-143, Dianal LR-396, Dianal LR-637, Dianal LR-162, Dianal LR469, Dianal LR-216, Dianal BR-50, Dianal BR-52, Dianal BR-60, Dianal BR-64, Dianal BR-73, Dianal BR-75, Dianal BR-77, Dianal BR-79, Dianal BR-80, Dianal BR-83, Dianal BR-85, Dianal BR-87, Dianal BR-88, Dianal BR-90, Dianal BR-93, Dianal BR-95, Dianal BR-100, Dianal BR-101, Dianal BR-102, Dianal BR-105, Dianal BR-106, Dianal BR-107, Dianal BR-108, Dianal BR-112, Dianal BR-113, Dianal BR-115, Dianal BR-116 and Dianal BR-117 (which are manufactured by Mitsubishi Rayon Co., Ltd.); Esrex PSE-0020, Esrex SE-0040, Esrex SE-0070, Esrex SE-0100, Esrex SE-1010 and Esrex SE-1035 (which are manufactured by Sekisui Chemical Co., Ltd.); Hymar ST95 and Hymar ST120 (which are manufactured by Sanyo Chemical Industry Co., Ltd.); and FM601 (which are manufactured by Mitsui Chemical Co., Ltd.).

Preferred examples of (e) the polyvinyl chloride resin include a polyvinyldene chloride resin, a vinyl chloride-vinyl acetate copolymer resin, a vinyl chloride-vinyl propionate copolymer resin or the like.

Preferred examples of (f) the polyvinyl butyral resin include a polyol resin, an ethyl cellulose resin, a cellulose resin such as a cellulose acetate resin, etc. The polyvinyl butyral resin is preferable to have the content of polyvinyl butyral greater than 70% by weight and an average degree of polymerization higher than 500 and more preferably higher than 1000. Commercially available examples of the polyvinyl butyral resin include Denka Butyral3000-1, Denka Butyral 4000-2, Denka Butyral 5000A and Denka Butyral 6000C (which are manufactured by Denki Kagaku Kogyo K.K.); Esrex BL-1, Esrex BL-2, Esrex BL-3, Esrex BL-S, Esrex BX-L, Esrex BM-1, Esrex BM-2, Esrex BM-5, Esrex BM-S, Esrex BH-3, Esrex BX-1 and Esrex BX-7 (which are manufactured by Sekisui Chemical Co., Ltd.); etc.

Preferred examples of (g) the polycaprolactone resin include a styrene-maleic anhydride resin, a polyacrylonitrile resin, a polyether resin, an epoxy resin, a phenol resin, etc.

Preferred examples of (h) the polyolefin resin include a polyethylene resin, a polypropylene resin, a copolymer resin of olefin such as ethylene or propylene and a vinyl monomer, an acrylic resin, etc.

These thermoplastic resins may be used individually or in any combination of two or more thereof.

It is preferred for the thermoplastic resin to satisfy the solid state property that the toner image receiving layer has to have. Two or more thermoplastic resins different in solid state property from one another may be used in combination. It is preferred that the thermoplastic resin has a molecular weight greater than the thermoplastic resin that is used for a toner. However, that this relationship of molecular weight between them is not always preferable according to the correlation of thermodynamic properties between them. For example, in the case where the thermoplastic resin for the toner image receiving layer has a softening temperature higher than the toner, it is preferred that the thermoplastic resin for the toner imager receiving layer has a molecular weight equal to or smaller than that of the toner. It is also preferred to use a mixture of thermoplastic resins that are the same in composition but different in average molecular weight. The thermoplastic resins used for the toner and the toner image receiving layer, respectively, are correlated with each other in terms of molecular weight as disclosed in Japanese Unexamined Patent Publication No. 8 (1996)-334915.

It is preferred that the distribution of molecular weight of the thermoplastic resin for the toner image receiving layer is wider than that for the toner. It is preferred for the thermoplastic resin for the toner image receiving layer to satisfy the solid state properties disclosed in, for example, Japanese Patent Publication No. 5 (1993)-127413, Japanese Unexamined Patent Publication Nos. 8(1996)-194394,8(1996)-334915, 8(1996)-334916,9(1997)-171265 or 10(1998)-221877.

The thermoplastic resin used for the toner image receiving layer is of an aqueous type such as a water-soluble resin or a water-dispersant resin for the following reasons (i) and (ii):

(i) The aqueous type of resin spins off no organic solvent emission in the coating and drying process and, in consequence, excels at environmental adaptability and workability;

(ii) A releasing agent such as wax is hardly soluble in water at an ambient temperature in many instances and is often dispersed in a solvent such as water or an organic solvent prior to use. The water-dispersant type of resin is stable and excels at manufacturing process adaptability. In addition, wet or aqueous coating causes wax to easily bleed onto a surface during a coating and drying process, so as thereby to bring out effects of the releasing agent (offset resistance, adhesion resistance, etc.).

The aqueous resin is not always bounded by composition, bond-structure, molecular geometry, molecular weight, molecular weight distribution and conformation inasmuch as it is of a water-soluble type or a water-dispersant type. Preferred examples of the hydrophilic or water-attracting group of polymer include a sulfonic acid group, a hydroxyl group, a carboxylic acid group, an amino group, an amid group, an ether group, etc.

Preferred examples of the water-soluble resin include those disclosed in Research Disclosure No. 17-643, page 26; No. 18-716, page 651; No.307-105, pages 873-874; and Japanese Unexamined Patent Publication No. 64(1989)-13546, pages 71-75. More specifically, available examples of the water-soluble resin include a vinyl pyrrolidone-vinyl acetate copolymer, a styrene-vinyl pyrrolidone copolymer, a styrene-maleic anhydride copolymer, water-soluble polyester, water-soluble acryl, water-soluble polyurethane, water-soluble nylon and a water-soluble epoxy resin. Further, gelatin is selected from a group of lime-treated gelatin, acidized gelatin, what is called delimed gelatin that has a reduced lime content as appropriate. These gelatin may be used individually or preferably used in any combination of two or more of them. Commercially available gelatins include various types of Pluscoat (which are manufactured by Gao Chemical Industry Co., Ltd.), various types of Fintex ES series (which are manufactured by Dainippon Ink & Chemical Inc.), both of which are of a water-soluble polyester; various types of Jurimar AT series (which are manufactured by Nippon Fine Chemical Co., Ltd.), Fintex 6161 and Fintex K-96 (which are manufactured by Dainippon Ink & Chemical Inc.), and Hyros NL-1189 and Hyros BH-997L (which are manufactured by Seiko Chemical Industry Co., Ltd.), all of which are of water-soluble acryl.

Preferred examples of the water-dispersant resin include a water-dispersant acrylic resin, a water-dispersant polyester resin, a water-dispersant polystyrene resin, a water-dispersant urethane resin, etc; emulsion such as an acryl resin emulsion, a polyvinyl acetate emulsion, an SBR (styrene.butadiene.rubber) emulsion or the like; and a water dispersion resin or emulsion of thermoplastic resin (a)˜(h), copolymer of the thermoplastic resin (a)˜(h), a mixture of the thermoplastic resin (a)˜(h), and any one of the thermoplastic resin (a)˜(h) that is cation-modified. These water-dispersant resins may be used individually or in any combination of two or more of thereof.

Commercially available examples of the water-ispersant resins include resins of Vyronal series (which are manufactured by Toyobo Co., Ltd.); resins of Pesuresin A series (which are manufactured by Takamatsu Oil & Fats Co., Ltd.); resins of Tafuton UE series (which are manufactured by Kao Co., Ltd.); resins of Polyester WR series (which are manufactured by Nippon Synthetic Chemical Industry Co., Ltd.) and resins of Eliel series (which are manufactured by Unitika Ltd.), all of which are of a polyester type, and resins of Hyros XE series, resins of KE series and resins of PE series (which are manufactured by Seiko Chemical Industry Co., Ltd.) and resins of Jurimar ET series (which are manufactured by Nippon Fine Chemical Co., Ltd.), all of which are of an acrylic type. It is preferred for the polymer to have a melt flow temperature (MFT) higher than an ambient temperature for storage before printing and lower than 100° C. for fixing toner particles. The content of thermoplastic resin is preferably higher than 50% by weight, and more preferably in a range of from 50 to 90% by weight, relative to the total weight of toner image receiving layer.

Releasing Agent

The releasing agent is blended in the toner image receiving layer to prevent the toner image receiving layer from offsetting. The releasing agent is not limited in type as long as it melts at a fixing temperature sufficiently enough to separate out onto the surface of the toner image receiving layer in a mal-distribution state and further forms a layer of releasing material on the toner image receiving layer resulting from being cooled and solidified.

The releasing agent having the function and effect mentioned above comprises at least one selected from a group of silicon compounds, fluorine compounds wax, and a matting agent and, more preferably from a group of a silicone oil, a polyethylene wax, a carnauba wax, silicone particles and polyethylene wax particles. Specifically, there are a number of releasing agents such as compounds disclosed in “Revised Edition: Property and Application of Wax” (published by Koushobou) and “Silicone Handbook” (published by Nikkan Kogyo Shinbun). Further, it is preferred to use silicone compounds, fluorine compounds and wax that are used for the toner disclose in Japanese Patent Nos. 2,838,498 and 2,949,558; Japanese Patent Publication Nos. 59(1984)-38581 and 4(1992)-32380; Japanese Unexamined Patent Publication Nos. 50(1975)-117433, 52(1977)-52640, 57(1982)-148755, 61(1986)-62056, 61(1986)-62057, 61(1986)-118760, 2(1990)-42451, 3(1991)41465, 4(1992)-212175, 4(1992)-214570, 4(1992)-263267, 5(1993)-34966, 5(1993)-119514, 6(1994)-59502, 6(1994)-161150, 6(1994)-175396, 6(1994)-219040, 6(1994)-230600, 6(1995)-295093, 7(1995)-36210, 7(1995)43940, 7(1995)-56387, 7(1995)-56390, 7(1995)-64335, 7(1995)-199681, 7(1995)-223362, 7(1995)-287413, 8(1996)-184992, 8(1996)-227180, 8(1996)-248671, 8(1996)-2487799, 8(1996)-248801, 8(1996)-278663, 9(1997)-152739, 9(1997)-160278, 9(1997)-185181, 9(1997)-319139, 9(1997)-319413, 10(1998)-20549, 10(1998)-48889, 10(1998)-198069, 10(1998)-207116, 11(1999)-2917, 11(1999)-449669, 11(1999)-65156, 11(1999)-73049 and 11(1999)-194542. These compounds can be used individually or in any combination of two or more thereof.

More specifically, preferred examples of the silicone compound include a non-modified silicone oil such as a dimethyl siloxane oil, a methyl hydrogen silicone oil and a phenylmethyl silicone oil (commercially available examples include KF-96, KF-96L, KF-96H, KF-99, KF-50, KF-54, KF-56, KF-965, KF-968, KF-994, KF-995, HIVAC, F-4, F-5 which are manufactured by Shinetsu Chemical Industry Co., Ltd.; SH200, SH203, SH490, SH510, SH550, SH710, SH704, SH705, SH7028A, SH7036, SM7060, SM7001, SM7706, SM7036, SH871107, SH8627 which are manufactured by Toray Dow Corning Silicone Co.; Ltd.; TSF400, TSF401, TSF404, TSF405, TSF431, TSF433, TSF434, TSF437, TSF450, TSF451, TSF456, TSF458, TSF483, TSF484, TSF4045, TSF4300, TSF4600, YF-33, YF-3057 YF-3800, YF-3802 YF-3804, YF-3807, YF-3897, XF-3905, XS69-A1753, TEX100, TEX101, TEX102, TEX103, TEX104, TSW831 which are manufactured by Toshiba Silicone Co., Ltd.); an amino-modified silicone oil (commercially available examples include KF-857, KF-858, KF-859, KF-861, KF-864 and KF-880 which are manufactured by Shinetsu Chemical Industry Co., Ltd.; SF8417 and SM8709 which are manufactured by Toray Dow Corning Silicone Co., Ltd.; and TSF4700, TSF4701, TSF4702, TSF4703, TSF4704, TSF4705, TSF4706, TEX150, TEX151 and TEX154 which are manufactured by Toshiba Silicone Co., Ltd.); a carboxy-modified silicone oil (commercially available examples include BY-16-880 manufactured by Toray Dow Corning Silicone Co., Ltd.; and TFS4770 and XF42-A9248 which are manufactured by Toshiba Silicone Co., Ltd.); a carbinol-modified silicone oil (commercially available examples include XF42-B0970 manufactured by Toshiba Silicone Co., Ltd.); a vinyl-modified silicone oil (commercially available examples include XF40-A1987 manufactured by Toshiba Silicone Co., Ltd.); an epoxy-modified silicone oil (commercially available examples include SF8411 and SF8413 which are manufactured by Toray Dow Coning Co., Ltd.; and TSF3965; and TSF3965, TSF4730, TSF4732, XF42-A4439, XF42-A4438, XF42-A5041, XC96-A4462, XC96-A4462, XC96-A4463, XC96-A4464 and TEX170 which are manufactured by Toshiba SiliconeCo., Ltd.); a polyether-modified silicone oil (commercially available examples include KF-351(A), KF-352(A), KF-353(A), KF-354(A), KF-355(A), KF-615(A), KF-618(A) and KF-945(A) which are manufactured by Shinetsu Chemical Industry Co., Ltd.; SH3746, SH3771, SH8421, SH8419, SH8400 and SH8410 which are manufactured by Toray Dow Corning Silicone Co., Ltd.; and TSF4440, TSF4441, TSF4445, TSF4446, TSF4450, TSF4452, TSF4453 and TSF4460 which are manufactured by Toshiba Silicone Co., Ltd.); a silanol-modified silicone oil; a methacryl-modified silicone oil; a mercapto-modified silicone oil; an alcohol-modified silicone oil (commercially available examples include SF8427 and SF8428 which are manufactured by Toray Dow Corning Silicone Co., Ltd.; and TSF4750, TSF4751 and XF42-B0970 which are manufactured by Toshiba Silicone Co., Ltd.); an alkyl-modified silicone oil (commercially available examples include SF8416 which is manufactured by Toray Dow Corning Silicone Co., Ltd.; and TSF410, TSF411, TSF4420, TSF4421, TSF4422, TSF4450, XF42-334, XF42-A3160 and XF42-A3161 which are manufactured by Toshiba Silicone Co., Ltd.); a fluorine-modified silicone oil (commercially available examples include SF1265 which is manufactured by Toray Dow Corning Silicone Co., Ltd.; and FQF502 which is manufactured by Toshiba Silicone Co., Ltd.); silicone rubber or silicone particulates (commercially available examples include SH851U, SH745U, SH55UA, SE4705U, SH502UA&B, SRX539U, SE6770-P, DY38-038, DY38-047, Trefil F-201, Trefil F-202, Trefil F-250, Trefil R-900, Trefil R902A, Trefil E-500, Trefil E-600, Trefil E-601, Trefil E-506 and Trefil BY29-119 which are manufactured by Toray Dow Corning Silicone Co., Ltd.; and Tospal 105, Tospal 120, Tospal 130, Tospal 145, Tospal 250 and Tospal 3120 which are manufactured by Toshiba Silicone Co., Ltd.); a silicone-modified compound of a silicone resin such as an olefin resin, a polyester resin, a vinyl resin, a polyamide resin, a cellulose resin, a phenoxy resin, a vinyl chloride-vinyl acetate resin, an urethane resin, an acryl resin, a styrene-acryl resin and copolymers of these resins (commercially available examples include Dialoma SP203, Dialoma SP712, Dialoma SP2105 and Dialoma SP2023 which are manufactured by Dainichiseika Color & Chemicals Mfg. Co., Ltd.; ModipaF S700, Modipa FS710, Modipa FS720, Modipa FS730 and Modipa FS770 which are manufactured by Nippon Oils & Fats Co., Ltd.; Saimack US-270, Saimack US-350, Saimack US-352, Saimack US-380, Saimack US413, Saimack US-450, Rezeda GP-705, Rezeda GS-30, Rezeda GF-150 and Rezeda GF-300 which are manufactured by Toa Gosei Chemical Industry Co., Ltd.; SH997, SR2114, SH2104, SR2115, SR2202, DCI-2577, SR2317, SE4001U, SRX625B, SRX643, SRX439U, SRX488U, SH804, SH840, SR2107 and SR2115 which are manufactured by Toray Dow Corning Silicone Co., Ltd.; and YR3370, TSR1122, TSR102, TSR108, TSR116, TSR117, TSR125A, TSR127B, TSR144, TSR180, TSR187, YR47, YR3187, YR3224, YR3232, YR3270, YR3286, YR3340, YR3365, TEX152, TX153, TEX171 and TEX172 (which are manufactured by Toshiba Silicone Co., Ltd.); and a reactive silicone compound such as an addition reaction type reactive silicone compound, a peroxide curing type reactive silicone compound and an ultraviolet curing type reactive silicone compound (commercially available examples include TSR1500, TSR1510, TSR1511, TSR1515, TSR1520, YR3286, YR3340, PSA6574, TPR6500, TPR6501, TPR6600, TPR6702, TPR6604, TPR6701, TPR6705, TPR6707, TPR6708, TPR6710, TPR6712, TPR6721, TPR6722, UV9315, UV9425, UV9430, XS56-A2775, XS56-A2982, XS56-A3075, XS56-A3969, XS56-A5730, XS56-A8012, XS56-B1794, SL6100, SM3000, SM3030, SM3200 and YSR3022 which are manufactured by Toshiba Silicone Co., Ltd.

Preferred examples of the fluorine compound include a fluorine oil (commercially available examples include Dyfloyl #1, Dyfloyl #3, Dyfloy 1#10, Dyfloyl #20, Dyfloyl #50, Dyfloyl #100, Unidyn TG-440, Unidyn TG-440, Unidyn TG-452, Unidyn TG-490, Unidyn TG-560, Unidyn TG-561, Unidyn TG-590, Unidyn TG-652, Unidyn TG-670U, Unidyn TG-991, Unidyn TG-999, Unidyn TG-3010, Unidyn TG-3020 and Unidyn TG-3510 which are manufactured by Daikin Kogyo Co., Ltd.; MF-100, MF-110, MF-120, MF-130, MF-160 and MF-160E which are manufactured by Tokem Products Co., Ltd.; Surflon S-111, Surflon S-112, Surflon S-113, Surflon S-121, Surflon S-131, Surflon S-132, Surflon S-141 and Surflon S-145 which are manufactured by Asahi Glass Co., Ltd.; and FC430 and FC431 which are manufactured by Mitsui Phluoro Chemicals Co., Ltd.); fluorine rubber (commercially available examples include LS63U which is manufactured by Toray Dow Corning Silicone Co., Ltd.); a fluorine-modified resin (commercially available examples include Modipa F200, Modipa F220, Modipa F600, Modipa F2020 and Modipa F3035 which are manufactured by Nippon Oils & Fats Co., Ltd.; Dialoma FF203 and Dialoma FF204 which are manufactured by Dainichiseika Color & Chemicals Mfg. Co., Ltd.; Surflon S-381, Surflon S-383, Surflon S-393, Surflon SC-101, Surflon SC-105, Surflon KH40 and Surflon SA-100 which are manufactured by Asahi Glass Co., Ltd.; EF-351, EF-352, EF-801, EF-802, EF601, TFE, TFEMA and PDFOH which are manufactured by Tokem Products Co., Ltd., and THV-200P which is manufactured by Sumitomo 3M Ltd.); a fluorosulfonate compound (commercially available examples include EF-101, EF-102, EF-103, EF-104, EF-105, EF-112, EF-121, EF122A, EF122B, EF-122C, EF-123A, EF-123B, EF-125M, EF-132, EF-135M, EF-305, FBSA, KFBS and LFBS which are manufactured by Tokem Products Co., Ltd.); a fluorosulfonic acid; a fluoride compound or a salt of fluoride compound (e.g. an anhydrous fluoric acid, a dilute fluoric acid, a fluoroboric acid, zinc fluoroborite, nickel fluoroborate, tin fluoroborite, lead fluoroborite, cupric fluoroborate, a hydrofluosilicic acid, potassium titanate fluoride, a perfluoro caprylic acid, perfluoro ammonium octanate, etc.); and inorganic fluoride (e.g. aluminum fluoride, potassium silicofluoride, potassium zirconate fluoride, zinc fluoride tetrahydrate, potassium fluoride, lithium fluoride, barium fluoride, tin fluoride, potassium fluoride, acidic potassium fluoride, magnesium fluoride, titanic fluoride, ammonium phosphate hexafluoride, potassium phosphate hexafluoride, etc.).

Preferred examples of the wax include synthetic carbon hydride, modified wax, hydrogenated wax, natural wax, etc.

More specifically, preferred examples of the synthetic carbon hydride include polyethylene wax (commercially available examples include Polyron A, Polyron 393 and Polyron H481 which are manufactured by Chukyo Oils & Fats Co., Ltd.; and Sunwax E-310, Sunwax E-330, Sunwax E-250P, Sunwax LEL-250, Sunwax LEL-800 and Sunwax LEL400P which are manufactured by Sanyo Chemical Industry Co. Ltd.); polypropylene wax (commercially available examples include Viscol 330-P, Viscol 550-P and Viscol 660-P which are manufactured by Sanyo Chemical Industry Co., Ltd.); Fischer-Tropsch wax (commercially available examples include FT-100 and FT-0070 which are manufactured by Nippon Seiro Co., Ltd.); and an acid amide compound or an acid imide compound such as amide stearate or imide phthalic anhydride (commercially available examples include Serozole 920, Serozole B495, Himicron G-270, Himicron G-110 and Hidrin D-757 which are manufacture by Chukyo Oils & Fats Co.).

Preferred examples of the modified wax include such as amine-modified polypropylene (commercially available examples include QN-7700 which is manufactured by Sanyo Chemical Industry Co., Ltd.); acrylic acid-modified wax, fluorine-modified wax or olefin-modified wax; urethane type wax (commercially available examples include NPS-6010 and HAD-5090 which are manufactured by Nippon Seiro Co., Ltd.); and alcohol type wax (commercially available examples include NPS-9210, NPS-9215, OX-1949 and XO-020T which are manufactured by Nippon Seiro Co., Ltd.).

Preferred examples of the hydrogenated wax include hydrogenated castor oil (commercially available examples include Castor Wax which manufactured by Ito Oil Manufacturing Co., Ltd.); derivatives of castor oil (commercially available examples include dehydrated castor oil DCO, DCO Z-1, DC0-Z2, castor oil fatty acid CO-FA, ricinoleic acid, dehydrated castor oil fatty acid DCO-FA, dehydrated castor oil fatty acid epoxyester D-4 ester, castor oil urethane acrylate CA-10, CA-20, CA-30, castor oil derivative MINERASOL S-74, MINERASOL S-80, MINERASOL S-203, MINERASOL S42X, MINERASOL S-321, special castor oil condensed fatty acid MINERASOL RC-2, MINERASOL RC-17, MINERASOL RC-55, MINERASOL RC-335, special castor oil condensed fatty acid ester MINERASOL LB-601, MINERASOL LB-603, MINERASOL LB-604, MINERASOL LB-702, MINERASOL LB-703, MINERASOL #11 and MINERASOL L-164 which are manufactured by Ito Oil Manufacturing Co., Ltd.); stearic acid (e.g. 12-hydroxystearic acid manufactured by Ito Oil Manufacturing Co., Ltd.); lauric acid; myristic acid; palmitic acid; behenic acid; sebacic acid (e.g sebacic acid manufactured by Ito Oil Manufacturing Co., Ltd.); undecylenic acid (e.g. undecylenic acid manufactured by Ito Oil Manufacturing Co., Ltd.); heptyl acid (e.g. heptyl acid manufactured by Ito Oil Manufacturing Co., Ltd.); maleic acid; higher maleic oil (commercially available examples include HIMALEIN DC-15, HIMALEIN LN-10, HIMALEIN 00-15, HIMALEIN DF-20 and HIMALEIN SF-20 which are manufactured by Ito Oil Manufacturing Co., Ltd.); blown oil (commercially available examples include Serbonol #10, Serbonol #30, Serbonol #60, Serbonol R-40 and Serbonol S-7 which are manufactured by Ito Oil Manufacturing Co., Ltd.); and cyclopentadiene oil (commercially available examples include CP Oil and CP Oil-S which are manufactured by Ito Oil Manufacturing Co., Ltd.).

The natural wax preferably comprises any one selected from a group of vegetable wax, animal wax, mineral wax and petroleum wax.

Preferred examples of the vegetable wax include carnauba wax (commercially available examples include EMUSTAR-0413 manufactured by Ito Oil Manufacturing Co., Ltd. and Serozole 524 manufactured by Chukyo Oils & Fats Co., Ltd.); castor oil (commercially available examples include castor oil manufactured by Ito Oil Manufacturing Co.); colza oils, soybean oils, sumac wax, cotton wax, rice wax, sugarcane wax, canderyla wax, Japan wax and jojoba oil. Among them, the carnauba wax, that has a melting temperature in a range of from 70 to 95° C., is especially preferred in terms of providing the electrophotographic image receiving sheet that excels in offset resistance, adhesion resistance, pass-though ability to pass though electrophotographic equipments, glossy impression, toughness against cracks, and capability for forming a high quality image.

Preferred examples of the animal wax include lanolin, spermaceti wax, blubber oil and wool wax.

Preferred examples of the mineral wax include montan wax, montan ester wax, ozokerite, ceresin, fatty acid ester (commercially available examples include Sensosizer DOA, Sensosizer AN-800, Sensosizer DINA, Sensosizer DIDA, Sensosizer DOZ, Sensosizer DOS, Sensosizer TOTM, Sensosizer TITM, Sensosizer E-PS, Sensosizer NE-PS, Sensosizer E-PO, Sensosizer E-4030, Sensosizer E-6000, Sensosizer E-2000H, Sensosizer E-9000H, Sensosizer TCP and Sensosizer C-1100 which are manufactured by Chukyo Oils & Fats Co., Ltd. Among them, the montan wax, that has a melting temperature in a range of from 70 to 95° C., is especially preferred in terms of providing the electrophotographic image receiving sheet that excels in offset resistance, adhesion resistance, pass-though ability to pass though electrophotographic equipments, glossy impression, toughness against cracks, and capability for forming a high quality image.

Preferred examples of the petroleum wax includes paraffin wax (commercially available examples include Paraffin Wax 155, 150, 140, 135, 130, 125, 120, 115, NHP-3, NHP-5, NHP-9, NHP-10, NHP-11, NHP-12, NHP-15G, SP-0160, SP-0145, SP-1040, SP-1035, SP-3040, SP-3035, NPS-8070, NPS-L-70, OX-2151, OX2251, EMUSTAR-0384 and EMUSTAR-0136 which are manufactured by Nippon Seiro Co., Ltd.; Serozole 686, Serozole 651-A, Serozole A, Serozole H-803, Serozole B460, Serozole E-172, Serozole 866, Serozole K-133, Hidrin D-337 and Hidrin E-139 which are manufactured by Chukyo Oils & Fats Co., Ltd.; 125° Paraffin, 125° FP Paraffin, and 130° Paraffin, 135° Parain, 135° H Paraffin, 140° Paraffin, 140° N Paraffin, 145° Paraffin and Paraffin Wax M which are manufactured by Nisseki Mitsubishi Oil Co., Ltd.); microcrystaline wax (commercially available examples include Hi-Mic-2095, Hi-Mic-3090, Hi-Mic-1080, Hi-Mic-1070, Hi-Mic-2065, Hi-Mic-1045, Hi-Mic-2045, EMUSTAR-0001 and EMUSTAR-042X which are manufactured by Nippon Seiro Co., Ltd.; Serozole 967 and Serozole M which are manufactured by Chukyo Oils & Fats Co., Ltd.; 155 Microwax and 180 Microwax which are manufactured by Nisseki Mitsubishi Oil Co., Ltd.); petrolatum (examples of commercially available petrolatum include OX-1749, OX-0450, OX-0650B, OX-0153, OX-261BN, OX-0851, OX-0550, OX-0750B, JP-1500, JP-056R and JP-011P which are manufactured by Nippon Seiro Co., Ltd.); etc.

The natural wax content of the toner image receiving layer (surface) is preferably in a range of from 0.1 to 4 g/m², and more preferably in a range of from 0.2 to 2 g/m². If the natural wax content is less than 0.1 g/m², significant deterioration of, in particular, offset resistance and adhesion resistance will occur On the other hand, if the natural wax content is beyond 4 g/m², the amount of wax is too large to form a high quality image. It is desired for the natural wax to have a melting temperature preferably in a range of from 70 to 95° C., and more preferably in a range of from 75 to 90° C., in light of, in particular, offset resistance and pass-though ability to pass though electrophotographic equipments.

Materials conventionally used as a matting agent are utilized. Solid particles used for the matting agent are classified into two types, namely inorganic particles and organic particles. Preferred materials for the inorganic matting particle include oxides such as a silica dioxide, a titanium oxide, a magnesium oxide and an aluminum oxide; salts of alkane earth metal such as barium sulfate, calcium carbonate and magnesium sulfate; silver halides such as a silver chloride and silver bromide; and glass.

More specifically, preferred examples of the inorganic matting agent include those disclose in West Germany Patent No. 2,529,321, British Patent Nos. 760775 and 1,260,772, U.S. Pat. Nos. 1,201,905, 2,192,241, 3,053,662, 3,062,649, 3,257,206, 3,322,555, 3,353,958, 3,370,951, 3,411,907, 3,437,484,3,523,022,3,615,554,3,635,714, 3,769,020,4,021,245 and 4,029,504.

Preferred materials for the organic matting agent include starch, cellulose ester (e.g. cellulose acetate propionate), cellulose ether (e.g. ethyl cellulose), and synthetic resins. The synthetic resin is preferably of a water-insoluble type or of a hardly soluble type. Preferred examples of the synthetic resin, water-insoluble or hardly soluble, include poly(meth)acrylic ester (e.g. polyalkyl(meth)acrylate, polyalkoxyalkyl(meth)acrylate, polyglycidyl(meth)acrylate); poly(meth)acrylamide; polyvinyl ester (e.g. polyvinyl acetate); polyacrylonitrile; polyolefin (e.g. polyethylene); polystyrene; a benzoguanamine resin, a formaldehyde condensed polymer; an epoxy resin; polyamide; polycarbonate; a phenol resin; polyvinyl carbazole; polyvinylidene chloride; etc. Copolymers comprising a combination of monomers used for the above mentioned polymers may be used.

In the case of utilizing the copolymer, the copolymer may contain a small chain of hydrophilic repeating unit. Examples of the monomer forming a hydrophilic repeating unit include acrylic acid, methacrylic acid, α-unsaturated carboxylic acid, β-unsaturated carboxylic acid, hydroxyalkyl(meth)acrylate, sulfoalkyl(meth)acrylate and styrene sulfonate.

Examples of the organic matting agent include those described in British Patent No. 1,055,713, U.S. Pat. Nos. 1,939,213, 2,221,873, 2,268,662, 2,322,037, 2,376,005, 2391,181, 2,701,245, 2,992,101, 3,079,257, 3,262,782, 3,443,946, 3,516,832, 3,539,344, 3,591,397, 3,754,924 and 3,767,448, and Japanese Unexamined Patent Publication Nos. 49(1974)-106821 and 57(1982)-14835. These solid particles may be used individually or in any combination of two or more. The average particle size is preferably in a range of from 1 to 100 μm, and more preferably in a range of from 4 to 30 μm. The amount of used solid particles is preferably in a range of from 0.01 to 0.5 g/m², and more preferably in a range of from 0.02 to 0.3 g/m².

Derivatives, oxides, refined products or mixtures of these solid particles may be used as the releasing agent that is added to the toner image receiving layer. Further, they may have a reactive substituent It is preferred that the releasing agent has a melting temperature in a range of from 70 to 95° C., and more preferably in a range of from 75 to 90° C., in terms of providing the electrophotographic image receiving sheet that excels in offset resistance and pass-though ability to pass though electrophotographic equipments. The content of releasing agent is preferably in a range of from 0.1 to 10% by weight, more preferably in a range of from 0.3 to 8.0% by weight, and most preferably in a range of from 0.5 to 5.0% by weight, with respect to the total amount of toner image receiving layer.

Plastisizing Agent

Various conventional plasticizing agents for resins can be used without any particular restrictions. The plasticizing agent has the function of controlling softening or melting of the toner image receiving layer due to heat and/or pressure applied in the toner fixing process. The plasticizing agent can be selected consulting “Handbook Of Chemistry” by Chemical Society of Japan (published by Maruzen), “Plasticizer—Theory and Applications—” by Kouichi Murai (published by Koushobou), “Study On Plasticizer Vol. 1” and “Study On Plasticizer Vol. 2” both by Polymer Chemistry Association, “Handbook: Rubber Plastics Compounding Chemicals” by Rubber Digest Ltd., etc.

Available as the plasticizing agent are, on one hand, high boiling point organic solvents and heat solvents and, on the other hand, compounds disclosed in, for example, Japanese Unexamined Patent Publication Nos. 59(1984)-83154, 59(1984)-178451, 59(1984)-178453, 59(1984)-178454, 59(1984)-178455, 59(1984)-178457, 61(1986)-209444, 61(1986)-2000538, 62(1987)-174745, 62(1987)-245253, 62(1987)-8145, 62(1987)-9348, 62(1987)-30247, 62(1987)-136646, and 2(1990% 235694. More specifically, those compounds disclosed in those publications include compounds of ester (e.g. phthalate, phosphate, fatty ester, abietate, adipate, sebacate, azelate, benzoate, butyrate, epoxidized fatty ester, glycolate, propionate, trimellitate, citrate, sulfonate, carboxylate, succinate, maleate, fumarate, stearate, etc.); amide (e.g. fatty amide, sulfoamide, etc.); ether; alcohol; lactone; polyethyleneoxy and the like.

Polymers of comparatively low molecular weight are used as the plasticizing agent. The molecular weight of the plastisizing agent is preferably lower than the molecular weight of a binder resin to be plastisized. More specifically, the molecular weight of the plastisizing agent is preferably lower than 15000 and more preferably lower than 5000. The polymer plastisizing agent is preferred to comprise the same polymer as the binder resin. For example, low molecular weight polyester is preferred for plastisizing a polyester resin. Further, oligomers can be used as the plastisizing agent.

There are commercially available plastisizing agents other than the above mentioned compounds. Commercially available examples include Adecasizer PN-170 and Adecasizer PN-1430 which are manufactured by Asahi Denka Kogyo K.K.; PARAPLEX-G-25, PARAPLEX-G-30 and PARAPLEX-G40 which are manufactured by HALL Corporation; and Estergum 8L-JA, Ester R-95, Pentaryn 4851, Pentaryn FK115, Pentaryn 4820, Pentaryn 830, Ruizol 28-JA, Picorastic A75, Picotex LC and Crystalex 3085 which are manufactured by Rika Hercules Co., Ltd. and the like.

It is possible to make arbitrary use of the plasticizing agent in order to alleviate stress or strain (physical strain due to elastic force or viscosity, strain due to material balance of molecules, main chains and pendants) that occurs when toner particles are buried in the toner image receiving layer. The plasticizing agent may be present in the toner image receiving layer in a microscopically dispersed state, a microscopically phase separated state like sea-island pattern or a state where the plasticizing agent has mixed with and dissolved in other components such as a binder sufficiently.

The content of plastisizing agent is preferably in a range of from 0.001 to 90% by weight, more preferably in a range of from 0.1 to 60% by weight, and most preferably in a range of from 1 to 40% by weight, with respect to the total amount of toner image receiving layer.

The plasticizing agent may be utilized for the purpose of optimizing competence to slip (improved sliding mobility due to a reduction in frictional force), offset of a fixing area (separation of a toner layer to the fixing area), a curling balance and static build-up (formation of electrostatic toner image).

Coloring Agent

Preferred examples of the coloring agent include fluorescent brightening agents, white pigments, colored pigments, dye, etc. The fluorescent brightening agent is a compound that has absorptive power in a near-ultraviolet range and generates fluorescence in a range of from 400 to 500 nm. A number of conventional fluorescent coloring agents can be used without being particularly bounded by types. Preferred examples of the fluorescent brightening agent include compounds disclosed in “The Chemistry of Synthetic Dyes” by K. Veen Ratarman, Vol. 8, Chapter 8. More specific examples of the compound include stilbene compounds, coumarin compounds, biphenyl compounds, benzooxazoline compounds, naphthalim de compounds, pyrazoline compounds, carbostyryl compounds, etc. Commercially available examples include White Fulfa PSN, White Fulfa PHR, White Fulfa HCS, White Fulfa PCS and White Fulfa B which are manufactured by Sumitomo Chemical Co., Ltd., and UVITEX-OB manufactured by Ciba-Geigy Ltd.

Preferred examples of the white pigment include inorganic pigments (e.g. a titanium oxide, calcium carbonate, etc.) that will be described in connection with fillers later. Preferred examples of the colored pigment include various pigments disclosed in, for example, Japanese Unexamined Patent Publication No. 63-44653, and azoic pigment (e.g. azolake pigment such as carmine 6B and red 2B; insoluble azo pigment such as monoazo yellow, disazo yellow, pyrazolo orange and Balkan orange; condensed azo pigment such as chromophthal yellow or chromophthal red); polycyclic pigment (e.g. phthalocyanine pigment such as copper phthalocyanine blue and copper phthalocyanine green; dioxazine pigment such as dioxazine violet; and isoindolynone pigment such as indolynone yellow; slen pigment such as perylene, perynon, flavantron and thioindigo); lake pigment (e.g. malachite green, rhodamine B, rhodamine G and Victoria blue B); and inorganic pigment (e.g. an oxide; a titanium dioxide; colcothar; sulfate such as precipitated barium sulfate; carbonate such as precipitated calcium carbonate; silicate such as hydrated silicate and anhydrous silicate; metal powder such as aluminum powder, bronze powder, blue powder, carbon black, chrome yellow, iron blue; and the like. These organic pigments may be used individually or in any combination of two or more. Among them, the titanium oxide is the most preferable pigment.

Various conventional dyes can be used as the coloring agent Preferred examples of the oil-soluble dye include anthraquinone compounds and azo compounds.

Preferred examples of the water-insoluble dye include vat dyes such as C.I.Vat violet 1, C.I.Vat violet 2, C.I.Vat violet 9, C.I.Vat violet 13, C.I.Vat violet 21, C.I.Vat blue 1, C.I.Vat blue 3, C.I.Vat blue 4, C.I.Vat blue 6, C.I.Vat blue 14, C.I.Vat blue 20, C.I.Vat blue 35 and the like; disperse dyes such as C.I. disperse violet 1, C.I. disperse violet 4, C.I. disperse violet 10, C.I. disperse blue 3,. C.I. disperse blue 7, C.I. disperse blue 58 and the like; and oil-soluble dyes such as C.I. solvent violet 13, C.I. solvent violet 14, C.I. solvent violet 21, C.I. solvent violet 27, C.I. solvent blue 11, C.I. solvent blue 12, C.I. solvent blue 25, C.I. solvent blue 55 and the like. Colored couplers used for silver halide photography can be preferably utilized.

The content of color agent is preferably in a range of from 0.1 to 8 g/m², and more preferably in a range of from 0.5 to 5 g/m², with respect to the toner image receiving layer (surface). If the content of coloring agent is less than 0.1 g/m², the toner image receiving layer has a light transmittance too high. On the other hand, if the content of coloring agent content is beyond 8 g/m², the toner image receiving layer is apt to become poor in tractability against adhesion resistance and cracks in some cases.

Filler

Preferred examples of the filler include organic fillers, inorganic fillers and those that have been known as stiffener, a loading material or a reinforcing material for a binder resin. The filler can be selected consulting “Handbook: Rubber Plastics Composing Chemicals” (Rubber Digest Ltd.), “New Edition Plastic Composing Chemicals-Fundamentals And Applications” (Taiseisha), or “Filler Handbook” (Taiseisha).

Preferred examples of the inorganic filler (or pigment) include silica, alumina, a titanium dioxide, a zinc oxide, a zirconium oxide, an iron oxide like mica, zinc white, a lead oxide, a cobalt oxide, strontium chromate, molybdenum pigments, smectite, a magnesium oxide, a calcium oxide, a calcium carbonate, mullite, etc. Among them, silica or alumina is particularly preferable as the filler. These fillers may be used individually or in combination of two or more. The filler desirably comprises a smaller size of particulates. If the particle size of filler is large, the toner image receiving layer is apt to have a rough surface.

There are two types of silica available for the filler, i.e. globular silica and amorphous silica. These silica can be synthesized in either a wet process, a dry process or an aerogel process. Surfaces of hydrophobic silica particles may be treated with a trimethylsilyl group or silicon. In this case, it is preferred to use colloidal silica particles. The average particle size of the silica particles is preferably in a range of from 200 to 5000 nm. Further, it is preferable to use porous silica particles. The average particle size of the porous silica particles is preferably in a range of from 4 to 120 nm, and more preferably in a range of from 4 to 90 nm. The average pour volume per unit weight is preferably in a range of from 0.5 to 3 ml/g.

There are two types of alumina available for the filler, i.e. anhydrous alumina and alumina hydrate. The anhydrous alumina may be of a crystal form of α,β, γ, δ, ζ, η, θ, κ, ρ or χ. The anhydrous alumina is more preferable rather than the alumina hydrate. Preferred examples of the alumina hydrate are monohydrate such as pseudoboemite, boenite and diaspore, or trihydrate such as gibbsite and bayerite. The average particle size of the alumina particles is preferably in a range of from 4 to 300 nm, and more preferably in a range of from 4 to 200 nm. The alumina particle is preferable to be porous. The average pore size of the porous alumina particles is preferably in a range of from 50 to 500 nm, and an average pour volume per unit weight is preferably in a range of from 0.3 to 3 ml/g.

The alumina hydrate can be synthesized in either a sol-gel process in which alumina is precipitated by adding ammonia in a solution of aluminum or a hydrolysis process in which an aluminate alkali is hydrolyzed. The anhydrous alumina can be derived by heating and dehydrating an alumina hydrate.

It is preferred to add the filler in a range of from 5 to 2000 parts by weight relative to 100 parts by dried weight of a binder of a layer to which the filler is added.

Cross-Linking Agent

The cross-linking agent is added for the purpose of providing the toner image receiving layer with storage stability and adjusting thermoplasticity of the toner image receiving layer. Compounds used for the cross-linking agent are those that have two or more reactive groups such as an epoxy group, an isocyanate group, an aldehyde group, an active halogen group, an active methylene group, an acetylene group or conventionally well known reactive group, in one molecule. In addition to those compounds, available compounds are those that have two or more groups capable of forming a bond through an ionic bond, a hydrogen bonding, a coordinate bond, etc.

Examples of the cross-linking agent include compounds conventionally known as a coupling agent, a hardening agent, a polymerizing agent, a polymerization promoter, a coagulating agent, a film forming ingredient, an auxiliary film forming ingredient and the like for resins. Preferred examples of the coupling agent include chlorosilane, vinylsilane, epoxysilane, aminosilane, alkoxyaluminum chelate, titanate coupling agents and those disclosed in “Handbook: Rubber Plastics Compounding Chemicals” (Rubber Digest Ltd.).

Electrostatic Charge Control Agent

It is preferred for the toner image receiving layer to contain an antistatic or electrostatic charge adjusting agent for the purpose of controlling toner transfer and toner adhesion and preventing toner image receiving layers from adhering to each other due to electrostatic charges.

Materials conventionally known as an electrostatic charge adjusting agent can be used. Preferred examples of the electrostatic charge adjusting agent include, but not limited to, surface-active agents such as cation surface-active agents, anion surface-active agents, ampholytic surface-active agents, nonionic surface-active agents and the like and, in addition, polyelectrolyte, electroconductive metal oxides and the like. Preferred examples include cation antistatic agents such as a quaternary ammonium salt, a polyamine derivative, cation-modified polymethylmethacrylate, cation-modified polystyrene and the like; anionic antistatic agents such as alkylphosphate, anion polymers and the like; and nonionic antistatic agents such as fatty ester, polyethylene oxides and the like. In the case where toner is charged with negative electricity, the cation antistatic agent or the nonionic antistatic agent is preferred.

Preferred examples of the electroconductive metal oxide include ZnO, TiO₂, SnO₂, Al₂O₃, In₂O₃, SiO₂, MgO, BaO, MoO₃, etc. These electroconductive metal oxides may be used individually or in the form of complex oxide thereof. The metal oxide may further be doped or contain with a hetero element. For example, ZnO may be doped with Al or In; TiO₂ may be doped with Nb or Ta; and SnO₂ may be doped with Sb, Nb or halogen.

Other Additives

A material for the toner image receiving layer may contain various additives for the purpose of improving stability of an image formed thereon and stability of the image receiving layer. In order to accomplish the purpose, preferred examples of the additive include an antioxidant, an anti-aging agent, an anti-degradation agent, anti-ozonant, an ultraviolet absorption agent, an metal complex, a light stabilizer, an antiseptic agent and a fungicide which are well known in the art.

Preferred examples of the antioxidant include chroman compounds, coumaran compounds, phenolic compounds (e.g. hindered phenol), hydroquinone derivatives, hindered amine derivatives, spiroindan compounds, etc. The antioxidants that are disclosed in, for example, Japanese Unexamined Patent Publication No. 61(1986)-159644 can be use.

The anti-aging agent can be selected consulting “Handbook: Rubber Plastics Compounding Chemicals 2nd Revised Edition” (1993, Rubber Digest Ltd.), pages 76-121.

Preferred examples of the ultraviolet absorption agent include benzotriazole compounds such as disclosed in U.S. Pat. No. 3,533,794, 4-thiazolidone compounds such as disclosed in U.S. Pat. No. 3,352,681, benzophenone compounds such as disclosed in Japanese Unexamined Patent Publication No. 46(1971)-2784, and ultraviolet absorption polymers such as disclosed in Japanese Unexamined Patent Publication No. 62(1987)260152.

Preferred examples of the metal complex include those disclosed in, for example, U.S. Pat. Nos. 4,241,155, 4,245,018 and 4,254,195, Japanese Unexamined Patent Publication Nos. 61(1986)-88256, 62(1987)-174741, 63(1988)-199428, 1(1989)-75568 and 1(1989)-74272. In addition, ultraviolet absorption agents and light stabilizers that are listed in “Handbook: Rubber Plastics Composing Chemicals 2^{nd} Revised Edition” (1993, Rubber Digest Ltd.), pages 122-137 are preferably used.

Photographic additives conventionally well known in the photographic art can be added to the material for the toner image receiving layer. Preferred examples of the photographic additive include those disclosed in Research Disclosure Magazine (RD) Nos. 17643 (December 1978), 18716 (November 1979) and 307105 (November 1989). These additives appear on the following pages:

| | | | RD |
|---|---|---|---|
| Additive | RD No. 17643 | RD No. 18716 | No. 307105 |
| Brightener | 24 | 648R | 868 |
| Stabilizer | 24-25 | 649R | 868-870 |
| Light Absorbent | 25-26 | 649R | 873 |
| (UV Absorbent) | | | |
| Color Image Stabilizer | 25 | 650R | 872 |
| Film Hardener | 26 | 651L | 874-875 |
| Binder | 26 | 651L | 873-874 |
| Plasticizer/Lubricant | 27 | 650R | 876 |
| Coating Auxiliary | 26-27 | 650R | 875-876 |
| Agent (Surface-active | | | |
| agent) | | | |
| Antistatic Agent | 27 | 650R | 976-977 |
| Matting Agent | | | 878-879 |

The toner image receiving layer is formed by applying a coating liquid containing a polymer on the support with a wire coater and then drying it. The melt flow temperature of the polymer is preferably higher than an ambient temperature for storage before printing and lower than 100° C. for toner particle fixation. Further, The dried weight of the toner image receiving layer is preferably in a range of from 1 to 20 g/m² and more desirably in a range of from 4 to 15 g/m², and a dried thickness is preferably in, but not limited to, a range of from 1 to 30 μm, and more preferably in a range of from 2 to 20 μm.

Solid State Properties of Toner Image Receiving Layer

The following description will be directed to solid state properties of the toner image receiving sheet. The 180 degree exfoliation strength of the toner image receiving layer at a fixing temperature of a fixing member is preferably les than 0.1 N/25 mm, and more preferably less than 0.041 N/25 mm. The 180 degree exfoliation strength is a measurement when estimated by the measuring method meeting JIS K86887 in which a surface material of the fixing member is used.

It is preferred for the toner image receiving layer to have a high degree of whiteness, specifically higher than 85% when estimated by the measuring method meeting JIS P8123. It is preferred for the toner image receiving layer to have a spectral reflection coefficient higher than 85% in a wavelength range of from 440 to 640 nm and a difference between the highest and the lowest spectral reflection coefficient less than 5% in the same wavelength range. It is also preferred for the toner image receiving layer to have a spectral reflection coefficient higher than 85% in a wavelength range of from 400 to 700 nm and a difference between the highest and the lowest spectral reflection coefficient less than 5% in the same wavelength range.

More specifically, when specifying the degree of whiteness expressed in CIE 1976 (L*a*b*) color space, it is preferred for the toner image receiving layer to have an L* value greater than 80, more desirably greater than 85 and most desirably greater than 90. The toner image receiving layer has a tinge of white that is desirable as neutral as possible and has specifically the value ((a*)²+(b*)²) expressed in CIE 1976 (L*a*b*) color space less than 50, more desirably less than 18 and most desirably less than 5.

It is preferred for the toner image receiving layer to have a high degree of glossiness, specifically, a degree of 45 degree glossiness higher than 60, more preferably higher than 75, and most preferably higher than 90, over a range of from a white state (which refers to a state where no toner is applied to the toner image receiving layer) to a black state (which refers to a state where toner is applied to the image receiving layer at the maximum density). However, the highest degree of 45 degree glossiness is preferably less than 110. If the degree of 45 degree glossiness is beyond 110, the toner image receiving layer has a metallic luster surface leading to an undesirable image quality. The degree of glossiness can be estimated by the measuring method meeting JIS Z8741.

It is preferred for the toner image receiving layer to have a high degree of smoothness, specifically, an arithmetic mean roughness (Ra) less than 3 μm, more preferably less than 1 μm, and most preferably less than 0.5 μm over a range of from the white state to the black state. The arithmetic mean roughness (Ra) can be estimated by the measuring method meeting JIS B0601, B0651 or B0652.

It is further preferred for the toner image receiving layer to satisfy at least one, more preferably two or more, and most preferably all, of the following solid state properties (1) to (8):

(1) The toner image receiving layer has a glass-transition temperature (Tg) desirably higher than 30° C., but within +20° C. from a glass-transition temperature of toner

(2) The toner image receiving layer has a 1/2 melting temperature (T1/2) preferably in a range of from 60 to 200° C., and more preferably in a range of from 80 to 170° C. In this instance, the 1/2 melting temperature (T1/2) is measurements of temperature at a half of a piston travel between start and end points of melt-off of the toner image receiving layer at each specified temperature when heating the toner image receiving layer at a programmed uniform rate applying a specified extrusion load to the piston under specified circumstances after preheating it at an initial setting temperature of, for example, 50° C. for a standing time of 300 seconds.

(3) The toner image receiving layer has a melt-off start temperature (Tfb) in a range of from 40 to 200° C. but within +50° C. from a melt-off start temperature of toner

(4) The toner image receiving layer has a temperature at which the toner layer attains viscosity of 1×10⁵CP higher than 40° C. but lower than that of toner

(5) The toner image receiving layer has a storage elastic modulus (G′) at a fixing temperature in a range of from 1×10² to 1×10⁵ Pa and a loss elastic modulus (G″) at the fixing temperature in a range of from 1×10² to 1×10⁵ Pa

(6) The toner image receiving layer has a loss tangent (G″/G′) at the fixing temperature, which represents a ration of loss elastic modulus (G″) to storage elastic modulus (G′), in a range of from 0.01 to 10

(7) The toner image receiving layer has a storage elastic modulus (G′) at a fixing temperature is in a range of from −50 Pa from a storage elastic modulus (G′t) for toner at fixing temperature to +2500 Pa from the storage elastic modulus (G′t)

(8) An angle of inclination of molten toner with respect to the toner image receiving layer is less than 50°, and especially less than 40°.

The aforementioned solid state property (1) can be estimated using a measuring device well known in the art as a differential scanning calorimeter (DSC). The aforementioned solid state properties (2) and (3) can be estimated using a measuring device such as Flow Tester CFT-500 or CFT-500D (which are manufactured by Shimazu Corporation). The aforementioned solid state properties from (5) to (7) can be estimated using a rotational rheometer such as Dynamic Analyzer RADII manufactured by Scientific Co., Ltd. Further, the aforementioned solid state property (8) can be estimated by a method disclosed in, for example, Japanese Unexamined Patent publication No. 8-334916, using a contact angle measuring device such as manufactured by Kyowa Surface Chemistry Co., Ltd.

It is preferred for the toner image receiving layer to have a surface electrical resistivity in a range of from 1×10⁶ to 1×10¹⁵ Ω/cm² under conditions of a temperature of 25° C. and a relative humidity of 65%. If the lower limit surface electrical resistivity of 1×10⁶ Ω/cm² is exceeded, this indicates that the amount of toner transferred to the toner image receiving layer is insufficient, then a toner image is apt to diminish in density. On the other hand, if the upper limit surface electrical resistivity of 1×10¹⁵ Ω/cm² is exceeded, electrostatic charges are generated too much to transfer a sufficient amount of toner to the toner image receiving layer. This excessive electrostatic charge generation results in a low density of toner image, adhesion of dust due to electrostatic charges built up during handling the electrophotographic image receiving sheet, miss-feed of the electrophotographic image receiving sheet, double feed of two or more electrophotographic image receiving sheets, generation of charge prints and an occurrence of fractional absence of toner transfer.

In this instance, the surface electrical resistivity can be estimated by the method meeting JIS K 6911 using a measuring device such as R8340 manufactured by Advantest Co., Ltd. Specifically, the electrical resistivity is measured under conditions of a temperature of 20° C. and humidity of 65% after a lapse of one minute from impression of a voltage of 100 V on a sample after moisturizing the sample for more than 8 hours under the same conditions.

[Backing Layer]

The backing layer is formed on the back surface of the support opposite to the toner image receiving layer for the purpose of providing back surface printing adaptability and improving back surface printing quality, curling balance and pass-though ability to pass though electrophotographic equipments. Though the backing layer is not always bound by color, it is preferred for the backing layer to be white in the case where the photoelectric image receiving sheet is of two-sided. The backing layer has a degree of whiteness and a spectral reflecting coefficient both higher than 85% similarly to the toner image receiving layer. In order to improve printing adaptability of both surfaces of the electrophotoelectric image receiving sheet, the backing layer may consist of a single layer or multiple layers and may be the same in structure as that at the toner image receiving layer. Further, the backing layer may be blended with additives, in particular, a matting agent and an electrostatic charge adjusting agent, that were previously described. In the case of using a releasing oil for the fixing rollers, the backing layer may be of an oil absorbing type. The thickness of the backing layer is ordinarily preferably between 0.1 and 10 μm.

[Other Layers]

As was previously mentioned, the electrophotographic image receiving sheet may be provided with other layers. Examples of the layer include a surface protective layer, an adhesion improvement layer, an intermediate layer, an under coating layer, a cushioning layer, an electrostatic charge adjusting or antistatic layer, a reflection layer, a tinge adjusting layer, a storage stability improvement layer, an anti-adhesion layer, an anti-curling layer, a smoothing layer, etc. These layers may be provided individually or in any combination of two or more.

Surface Protective Layer

The surface protective layer is formed on the surface of the electrophotographic image receiving sheet for the purpose of protecting the surface thereof, improving storage stability, handling adaptability and pass-though ability to pass though electrophotographic equipments, and providing the electrophotographic image receiving sheet with writability and anti-offset resistance. The surface protective layer may be single-layered or multi-layered. Although various types of thermoplastic resin binder or thermosetting resin binder can be used for the surface protective layer, it is preferred to use the same resin binder as used for the toner image receiving layer. The binder of the surface protective layer is not always the same in thermo dynamic and electrostatic characteristics as those of the toner image receiving layer and can be optimized so as to meet the surface protective layer.

The surface protective layer may be blended with various additives that are usable for the toner image receiving layer, in particular the matting agent as well as the releasing agent described in connection with the electrophotographic image receiving sheet. It is preferred for the outermost layer of the electrophotoelectric image receiving sheet (e.g. the surface protective payer when it is formed) to have high compatibility with toner in light of fixing performance. Specifically, it is preferred for the outermost layer to have a contact angle with molten toner in a range of from 0 to 40°.

Adhesion Improvement Layer

The electrophotographic image receiving sheet is preferably provided with an adhesion improvement layer for the purpose of improving adhesion between the toner image receiving layer and the substrate. The adhesion improvement layer may be blended with various additives including, in particular a cross-linking agent, that were previously described. Further, it is preferred for the electrophotographic image receiving sheet to be provided with a cushioning layer between the adhesion improvement layer and the toner image receiving layer for the purpose of improving toner acceptability.

Intermediate Layer

The electrophotographic image receiving sheet may be provided with an intermediate layer between the substrate and the adhesion improvement layer, between the adhesion improvement layer and the cushioning layer, between the cushioning layer and the toner image receiving layer, or between the toner image receiving layer and the storage stability improvement layer. In the case where the electrophotographic image receiving sheet consists of the substrate, the toner image receiving layer and the intermediate layer, it is of course to put the intermediate layer between the substrate and the toner image receiving layer.

The electrophotographic image receiving sheet with these additional layers is not bound by thickness, and it is preferred to have a thickness in a rage of from 50 to 350 μm, and more preferably in a range of from 100 to 280 μm, as appropriate.

(Toner)

In use of the electrophotographic image receiving sheet for image printing or image copying, toner is applied to the toner image receiving layer. The toner contains at least a binder resin, a coloring agent and, if needed, a releasing agent.

Binder Resin

Preferred examples of the binder resin include styrene type resins such as styrene and parachlorostyrene; vinyl ester type resins such as vinyl naphthalene, vinyl chloride, vinyl bromide, vinyl fluoride, vinyl acetate, vinyl propionate, vinyl benzoate and vinyl butarate; methylene aliphatic carboxylate ester type resins such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate and butyl methacrylate; vinyl nitrile type resins such as acrylonitrile, methacrylonitrile and acrylamide; vinyl ether type resins such as vinyl methyl ether, vinyl ethyl ether and vinyl isobutyl ether; N-vinyl compounds such as N-vinyl pyrrole, N-vinyl carbazole, N-vinyl indole and N-vinyl pyrrolidone; homopolymers or copolymers of vinyl monomers of vinyl carboxylate such as methacrylic acid, acrylic acid and cinnamic acid; and various types of polyester. These binder resin may be used in combination with various wax. It is preferred to use the same type of resin as used for the toner imager receiving layer.

Coloring Agent

Coloring agents that are used for ordinary toner can be used without any restrictions. Preferred examples of the coloring agent include various pigments, e.g. carbon black, chrome yellow, Hansa yellow, benzidine yellow, slen yellow, quinoline yellow, permanent orange GTR, pyrazolone orange, Vulcan orange, Watchung red, permanent red, brilliant carmine 3B, brilliant carmine 6B, Deipon oil red, pyrazalone red, redole red, rhodamine B lake, lake red C, rose Bengal, aniline blue, ultramarine blue, Carco oil blue, methylene blue chloride, phthalocyanine blue, phthalocyanine green and malachite green oxalate; and various dyes e.g. acridine dyes, xanthene dyes, azoic dyes, benzoquinone dyes, axine dyes, anthraquinone dyes, thioindigo dyes, dioxazine dyes, thiazine dyes, azomethine dyes, indigo dyes, thioindigo dyes, phthalocyanine dyes, aniline black dyes, polymethine dyes, triphenylmethane dyes, diphenylmethane dyes, thiazine dyes, thiazole dyes and xanthene dyes. These pigments or dyes may be used individually or in any combination of two or more.

It is preferred for the toner to contain the coloring agent in a range of from 2 to 8% by weight. The toner does not lose tinting power when containing the coloring agent higher than 2% by weight nor diminish transparency when containing the coloring agent lower than 8% by weight.

Releasing Agent

Although all types of wax conventionally known in the art can be used as the releasing agent for the toner in principle, particularly effective examples of the releasing agent include higher crystalline polyethylene wax with a comparatively low molecular weight, Fischer-Tropsch wax, amide wax and polar wax containing nitrogen such as a urethane compound. It is preferred for the polyethylene wax to have a molecular weight less than 1000, and more preferably in a range of from 300 to 1000.

It is preferred to use the compound having an urethane bond because it keeps itself in a solid state due to coagulation power of its polar group even though it has only a small molecular weight and can be set to a higher melting temperature with respect to a low molecular weight. It is preferred for the compound to have a molecular weight in a range of from 300 to 1000. Specifically, preferred examples of the raw material for the compound include a combination of a diisocyanate compound and monoalcohol, a combination of monoisocyanate and monoalcohol, a combination of dialcohol and monoisocyanate, a combination of trialcohol and monoisocyanate, a combination of triisocyanate and monoalcohol and the like. In order to keep the compound from having a higher molecular weight, it is preferred to combine a compound of multifunctional group and a compound monofunctional group and is important for the compound to have quantitatively equivalent functional groups.

Preferred examples of monoisocyanate compound include dodecyl isocyanate, phenyl isocyanate, derivatives of phenyl isocyanate, naphthyl isocyanate, hexyl isocyanate, benzyl isocyanate, butyl isocyanate, aryl isocyanate and the like. Preferred example of diisocyanate compound include tolylene diisocyanate, 4, 4′ diphenyl methane diisocyanate, toluene diisocyanate, 1,3-phenylene diisocyanate, hexamethylene diisocyanate, 4-methyl-m-phenylene diisocyanate, isophorone diisocyanate and the like.

Preferred examples of monoalcohol include methanol, ethanol, propanol, butanol, pentanol, hexanol, heptanol and other general alcohol. Preferred example of dialcohol include, but not limited to, various glycol such as ethylene glycol, diethylene glycol, triethylene glycol, trimethylene glycol, etc. Preferred example of trialcohol include, but not limited to, trimethylol propane, triethylol propane, trimethanol ethane, etc.

Each of the urethane compounds may be blended with the toner together with a resin and/or a coloring agent like ordinary releasing agents so as to provide a mixed pulverize type of toner. When using the compound for toner in an emulsion polymerization-coagulation melting method, the compound is dispersed in water together with polyelectrolytes such as an ionic surface-active agent, a polymer acid and a polymer base, heated to a temperature higher than its melting temperature and sheared to particulates of less than 1 μm. A dispersion liquid of the releasing particulates can be blended with the toner together with a dispersion liquid of resin particulates and/or a liquid of coloring agent particulates.

Other Components

The toner may be blended with other components such as an internal additive, an electrostatic charge control agent, inorganic particulates, etc. Preferred examples of the additive include various magnetic materials: specifically metals such as ferrite, magnetite, reduced iron, cobalt, nickel, manganese, etc.; alloys; and compounds containing these metals.

Preferred examples of the electrostatic charge control agent include dye such as quaternary ammonium salt compounds, nigrosin compounds, a complex of aluminum, iron or chrome; and various triphenylmethane pigments ordinarily used as antistatic agent. In light of controlling ion strength having an effect on stability of the toner during coagulation and melting and reducing wastewater pollution, it is preferred to use an electrostatic charge adjusting agent that is hardly dissolved in water.

Preferred examples of the inorganic particulate include all of the conventional additives that are externally applied to surfaces of toner particles such as silica, alumina, titania, calcium carbonate, magnesium carbonate, tricalcium phosphate, etc. It is preferred to use in the form of a dispersion of the inorganic particulates with an ionic surface-active agent, polymer acid and/or a polymer base.

Surface-active agents can be used for the purpose of emulsion polymerization, seed polymerization, dispersion of pigment, dispersion of resin particles, dispersion of releasing agent, coagulation and stabilization of them. It is effective to use anion surface-active agents such as a sulfate salt surface-active agent, a sulfonate surface-active agent, a phosphate surface-active agent, a soap surface-active agent, etc.; cationic surface-active agents such as an amine salt surface-active agent, a quaternary ammonium salt surface-active agent, etc.; and nonionic surface-active agents such as polyethylene glycol surface-active agent, a surface-active agent of alkylphenol ethylene oxide adduct, polyhydric alcohol surface-active agent, etc. In order to disperse these additives, it is possible to use popular dispersing machines such as a rotary shearing type of homogenizer, a ball mill, a sand mill or the like.

The toner may further contain an external additive if needed. Preferred examples of the additive include inorganic particles such as SiO₂ particles, TiO₂ particles, Al₂O₃ particles, CuO particles, ZnO particles, SnO₂ particles, Fe₂O₃ particles, MgO particles, BaO particles, CaO particles, K₂O particles, NaO₂ particles, ZrO₂ particles, CaO.SiO₂ particles, K₂O.(TiO₂), particles, Al₂O₃.2SiO₂ particles, CaCO₃ particles, MgCO₃ particles, BaSO₄ particles or MgSO₄ particles; and organic particles such as fatty acid particles, particles of a derivative of fatty acid, metal acids of them, fluorocarbon resin particles, polyethylene resin particles or acryl resins particles. It is preferred for these particles to have an average particle size in a range of from 0.01 to 5 μm, and more preferably in a range of from 0.1 to 2 μm.

Although various methods may be used to manufacture the toner, it is preferred to employ a method comprising the following processes (i) to (iii):

(i) A process of preparing a dispersion liquid of coagulated particles by forming the coagulated particles in a dispersion liquid of resin particles

(ii) A process of forming particulate-adhered coagulated particles by mixing a dispersion liquid of particulates to the dispersion liquid of coagulated particles

(iii) A process of forming toner particles by heating and melting the particulate-adhered coagulated particles.

Solid State Properties

The volumetric average particle size of toner particles is preferably in a range of from 0.5 to 10 μm. If the volumetric average particle size is smaller than 0.5 μm, the toner has adverse effects on its handling (replenishing and cleaning adaptability and flowability) and on particle productivity. On the other hand, if the volumetric average particle size exceeds 10 μm, the toner also has an adverse effect on image quality and resolution due to graininess and transferability.

It is preferred for the toner to have a volumetric average particle size distribution index (GSDv) equal to or less than 1.3 while satisfying the particle size requirement. It is further preferred for the toner to have a ratio (GSDv/GSDn) of a volumetric average particle size distribution index (GSDv) relative to a number average particle size distribution index (GSDn) equal to or greater than 0.9. In addition, it is preferred for the toner to have an average of the profile factor expressed by the following equation in a range of from 1.00 to 1.50 while satisfying the volumetric average particle size requirement.

Profile factor=(π×L²)/(4×S)

where L is the greatest size of toner particle and S is the projected area of toner particle.

When the toner satisfies the requirements as set forth above, the toner has an positive effect on image quality, in particular graininess and resolution of an image, prevents an occurrence of fractional absence of toner transfer and/or an occurrence of blurred toner image, and is hardly apt to have an adverse effect on its handling adaptability even though the average particle size is insufficiently small. In this instance, it is preferred for the toner itself to have a storage elastic modulus (G′) (that is measured with an angular frequency of 10 rad/sec) at a temperature of 150° C. in a range of from 0.10 to 200 Pa in light of improving image quality and preventing an occurrence of offset in the fixing process.

(Image Forming Process)

The following description will be directed to processes of forming an image on the electrophotographic image receiving sheet The image forming process according to a first embodiment comprises a step of forming a toner image on an electrophotographic image receiving sheet, a step of heating and applying pressure on the electrophotographic image receiving sheet from the toner image formed surface between a fixing belt and a roller, and a step of removing the electrophotographic image receiving sheet from the fixing belt after cooling it.

The image forming process according to a second embodiment comprises a step of forming a toner image on an electrophotographic image receiving sheet, a step of fixing the toner image with a heating roller, a step of heating and applying pressure on the electrophotographic image receiving sheet from the toner image formed surface between a fixing belt and a roller, and a step of removing the electrophotographic image receiving sheet from the fixing belt after cooling it.

In this instance, it is preferred to heat and press the electrophotographic image receiving sheet to a temperature higher than the softening point of the thermoplastic resin used in the toner image receiving layer with the fixing belt and roller as a heating and pressing means and then to release it from the belt of a belt-fixing type smoothing device after cooling. For example it is preferred to use a cooling and releasing belt fixing type smoothing device. It is preferred to use, but limited to, a combination of heating roller, a pressure roller and an endless belt is used as the heating and pressing means of the cooling and heating belt fixing type smoothing device. It is also preferred to use, but not limited to, a cooling device capable of blasting cold air and adjustable air temperature or a heat sink.

When bringing the electrophotographic image receiving sheet into contact with the heating and pressing means of the cooling and heating belt fixing type smoothing device, it is preferred to heat the electrophotographic image receiving sheet. Although the pressing process is not particularly bounded by type, it is preferred to apply nip pressure preferably in a range of from 1 to 100 kg/cm², and more preferably from 5 to 30 kg/cm², to the electrophotographic image receiving sheet in the view point of a water resisting property, distinguished surface smoothness and satisfactory gloss. Further, it is preferred to heat the electrophotographic image receiving sheet to a temperature higher than the softening point of a thermoplastic resin of the toner image receiving layer that is preferably in a range of from 80 to 200° C. It is also preferred to cool electrophotographic image receiving sheet at a temperature lower than 80° C., more preferably in a range of from 20 to 8° C., that is sufficiently low to solidify the thermoplastic resin of the toner image receiving layer.

It is preferred to use a fixing belt with a surface made of a thin film of at least one selected from the group of silicone rubber, fluorocarbon rubber, silicone resin and fluorocarbon resin. It is more preferred to use a fixing belt with a fluorocarbon siloxane rubber layer formed on a surface thereof or a fixing belt with a silicone rubber under layer and a fluorocarbon rubber layer on a surface thereof.

Preferred examples of the fluorocarbon siloxane rubber include those having a perfluoroalkyl ether group and/or a perfluoroalkyl group in a principal chain such as (A) a fluorocarbon polymer composed of fluorocarbon siloxane as a principal component and having an aliphatic unsaturated group; (B) organopolysiloxane and/or fluorocarbon siloxane that has more than two ≡SiH groups in one molecule and have the content of ≡SiH group from one to four times in molar quantity as much as the quantity of aliphatic unsaturated group in the composition of fluorocarbon siloxane rubber; (C) filler; and (D) a hardened composition of fluorocarbon siloxane rubber having an effective amount of catalyst.

The fluorocarbon siloxane that is used as principal component of (A) the fluorocarbon polymer is expressed by the following general formula (1):

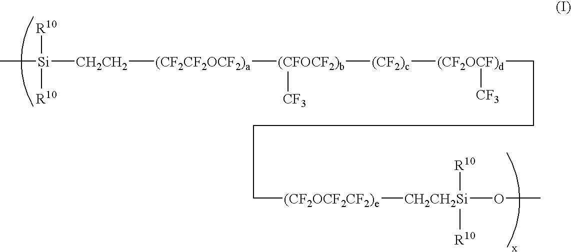

where

R¹⁰: a substitutable or non-substitutable univalent hydrocarbon group having a carbon number between 1 and 8, desirably an alkyl group having a carbon number between 1 and 8 or an alkenyl group having a carbon number of 2 or 3, and more desirably a methyl group;

a, e: 0 or 1;

b, d: an integer between 1 and 4;

c: 0 or an integer between 1 and 8, and

x: an integer of 1 or greater than 1, preferably between 10 and 30.

A specific example of the component (A), i.e. the fluorocarbon polymer, is expressed by the following formula (II):

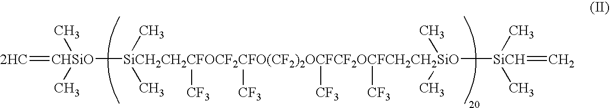

A preferred example of the component (B), i.e. organopolysiloxane having ≡SiH groups is organohydrogen polysiloxane having at least two hydrogen atoms bonded to silicon atoms in one molecule.

In the case where the component (A), i.e. the fluorocarbon polymer, has an aliphatic unsaturated hydrocarbon group, the organohydrogen polysiloxane can be used as a hardening agent for the composition of fluorocarbon siloxane rubber. That is, in this case, a hardened material is formed through an addition reaction occurring between an aliphatic unsaturated hydrocarbon group of the fluorocarbon siloxane and an atom bonded to a silicon atom of the organohydrogen polysiloxane. Various organohydrogen polysiloxane that are used for an addition reaction type hardened composition of silicon rubber can be used as the organohydrogen polysiloxane. It is preferred for the organohydrogen polysiloxane to have ≡SiH groups at least one, desirably one to five, for one aliphatic unsaturated hydrocarbon group of the component (A) i.e. the fluorocarbon siloxane.

A preferred example of the fluorocarbon having ≡SiH groups is the unit expressed by the formula (I) or a unit expressed by the formula (III) which has a dialkyl hydrogensiloxy group for R¹⁰ of the formula (I) and an end ≡SiH group that is a dialkylhydrogen siloxy group or a silyl group.

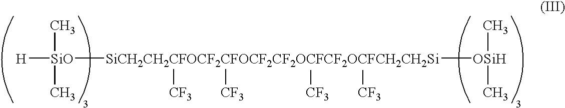

Preferred examples of the component (C) include various fillers that are conventionally used in general silicon rubber compositions; e.g. a reinforcing filler such as aerosol silica, precipitation silica, carbon powder, a titanium dioxide, an aluminum oxide, quartz powder, talc, sericite or bentonite; and a fiber filler such an asbestos, a glass fiber or an organic fiber.

Preferred examples of the catalyst for the component (D) include various catalysts well known as an addition reaction catalyst in the art such as a chloroplatinic acid; an alcohol-modified chloroplatinic acid; a complex of chloroplatinic acid and olefin; a composition of platinum black or palladium supported by alumina, silica or carbon; a complex of rhodium and olefin; and elements of the VIII group of periodic table or their compounds such as chlorotris (triphenylphosphine) rhodium (Wilkinson catalyst) and rhodium(III) acetylacetonate. It is preferred to use the complex as a solution with an alcohol solvent, an ether solvent or a hydrocarbon solvent.

The fluorocarbon siloxane rubber composition may be added with various compounding agents as needed as long as not spoiling the purpose of the present invention to improve chemical resistance. Preferred examples of the compounding agent include a dispersing agent such as diphenylsilanediol, dimethylpolysiloxane with a low degree of polymerization and a hydroxyl group or hexamethyldisilazane; a thermal resistance improving agent such as a ferrous oxide, a ferric oxide, a cerium oxide, a ferric octylate; and a coloring agent such as pigment.

The fixing belt is prepared by applying a surface coating layer of the composition of fluorocarbon siloxane rubber to a belt made of a heat-resistant resin or a metal and curing it with heat Otherwise, the fixing belt may be coated with a coating liquid of the composition of fluorocarbon siloxane rubber diluted with a solvent such as m-xylenehexafluoride or benzotrifluoride by a general coating process such as spray coating, dip coating or knife coating, as appropriated.

Though the heat curing is not bound by temperature and/or time, it is preferably performed at a temperature in a range of from 100 to 500° C. for a curing time in a range of from 5 seconds to 5 hours according to types of the belt body and belt manufacturing processes. The thickness of the layer of fluorocarbon siloxane rubber of the fixing belt is preferably in, but not limited to, a range of from 20 to 500 μm and more preferably a range of from 40 to 200 μm.

The surface roughness, more specifically, the arithmetic mean roughness (Ra), of the fixing belt is preferably less than 20 μm, more preferably less than 5 μm, and most preferably less than 1 μm, in light of distinguished surface smoothness and satisfactory glossy image formation. The arithmetic mean roughness (Ra) can be measured by a method meeting JIS B0601, B0651 or B0652.

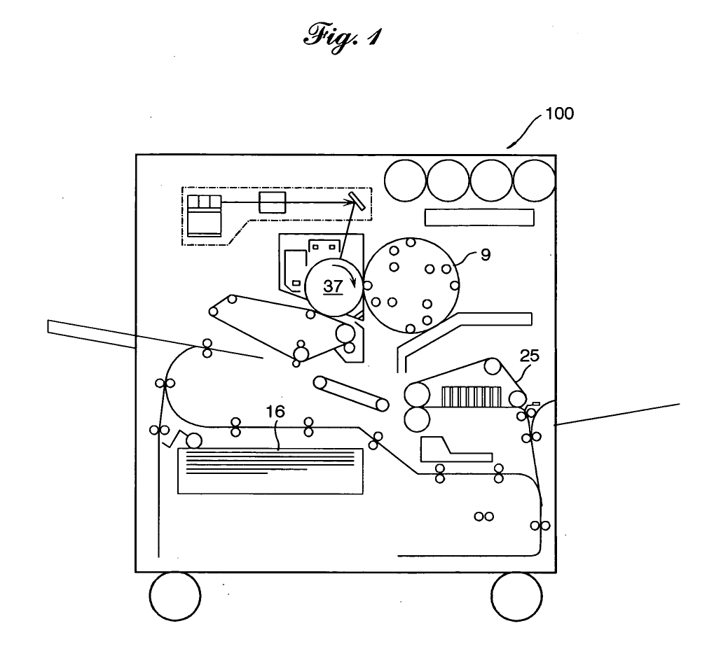

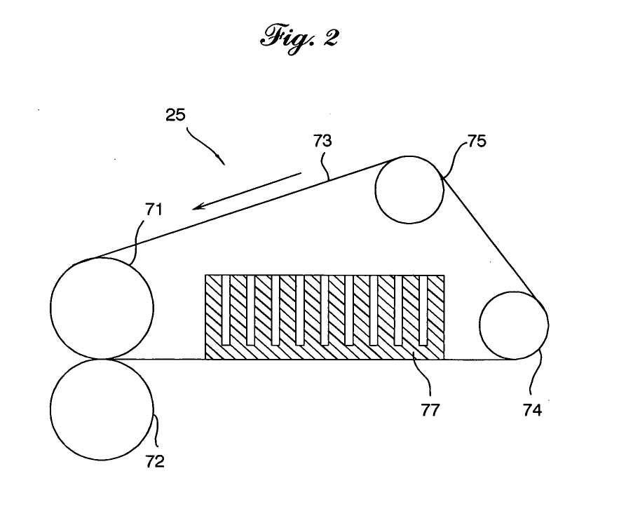

FIG. 1 shows an electrophotographic machine 100 according to a preferred embodiment of the present invention in which a belt type fixing device that is prepared by making an alteration to the belt fixing type smoothing device of, for example, Laser Printer DCC-500 by Fuji Xerox Co., Ltd. is installed. The electrophotographic machine 100 comprises a photosensitive drum 37, a developing device 9, an intermediate transfer belt 31, a stack of recording sheets 16, i.e. the electrophotographic image receiving sheets, and a belt type fixing device 25 that is depicted in detail in FIG. 2.

Referring to FIG. 2, the belt type fixing device 25 comprises a heating roller 71, a releasing roller 74 and a tensioning roller 75 which are installed in a trigonal arrangement, an endless belt 73 mounted on these rollers 71, 74 and 75, and a pressure roller 72 urged against the heating roller 71. The belt type fixing device 25 is further provided a heat sink 77 disposed between the heating roller 71 and the releasing roller 74 and operative to forcibly cool the endless belt 73.

The electrophotographic image receiving sheet is transported by the endless belt 73 and cooled by the heat sink 77. More specifically, the electrophotographic image receiving sheet with a color toner image transferred and fixed onto an upper surface thereof is introduced into a nip between the heating roller 71 and the pressure roller 72. During passing through between the heating roller 71 and the pressure roller 72, the color toner image is fused at a temperature in a range of, for example, from 120 to 130° C. and fixed to the toner image receiving layer of the electrophotographic image receiving sheet. Thereafter, the electrophotographic image receiving sheet with the toner image receiving layer remaining in contact with the endless belt 73 is transported by the endless belt 73. During the transportation, the color toner image transferred to the toner image receiving layer is cooled by the heat sink 77 so as thereby to be solidified. Then, the electrophotographic image receiving sheet is released from the endless belt 73 by the releasing roller 74 with the assistance of its own stiffness. Thereafter, the belt type fixing device 25 cleans the surfaces of the endless belt 73 to remove remaining toner and dust so as to get prepared for fixing of another electrophotographic image receiving sheet.

Formation of an image on the electrophotographic image receiving sheet is not bounded by the process described above and completed any conventional process using the fixing belt.

Further, formation of a color image on the electrophotographic image receiving sheet is achieved by any conventional full color electrophotographic machines that comprise an sheet transportation device, a latent image forming device, a developing device disposed adjacent to the latent image forming device and, according to machines, an intermediate toner image transfer device disposed adjacent to the sheet transportation device and the latent image forming device.

In order to improve image quality, it has been known to use an adhesion transfer process or a heat-assisted transfer process such as disclosed in Japanese Unexamined Patent Publication Nos. 63(1988)-113576 and 5(1993)-341666 in place of or in combination with the electrostatic transfer process or a bias-roller transfer process. The heat-assisted transfer process using an intermediate transfer belt is preferable in the case where small particle size of toner is used.

According to the image forming process described above, even though an oilless type electrophotographic machine that needs no fixing oil is used, it is possible to feed the electrophotographic image receiving sheets stably without detriment to release property of the electrophotographic image receiving sheet and the toner or offset of the electrophotographic image receiving sheet and the toner with the consequence that an image is formed with more than ever satisfactory gloss and rich photographic feeling.

The present invention will be described in connection with, but not limited to, electrophotographic image receiving sheets by way of working and comparative examples. In the following description, the terms “%/” and “part” as used herein shall mean “% by weight” and “part by weight,” respectively.

### WORKING EXAMPLES 1 TO 6 AND COMPARATIVE EXAMPLES 1 TO 3

Preparation of Base Sheet

Paper pulp for the base sheet was prepared by beating bleached kraft pulp of a broadleaf tree (LBKP) to 300 ml (Canadian Standard Freeness: C.S.F.) so as to adjust pulp fibers in fiber length to 0.6 mm with a disk refiner and then added with the following additives in % by weight with respect to pulp weight.

| Additives | Weight (%) |
|---|---|
| Cation starch | 1.2 |
| Alkylketenedimer (AKD) | 0.5 |
| Anion polyacrylamide | 0.3 |
| Epoxidized fatty acid amine (EFA) | 0.2 |
| Polyamide polyamine epichlorohydrin | 0.3 |

In this instance, an alkyl component of the alkylketenedimer (AKD) is derived from fatty acid primarily composed of behenic acid and a fatty acid component of the epoxidized fatty acid amine (EFA) is derived from fatty acid primarily composed of behenic acid.

The paper pulp was processed to provide 160 g/m² by basic absolute dry weight of base paper by a Fourdrinier machine. The base papers for each of working examples 1 to 6 (WE1-WE6) and comparative examples 1 to 3 (CE1-CE3) was subjected to surface sizing with a size press machine at a midpoint of a dry zone of the Fourdrinier machine so as to cause an alkali metallic salt, an alkaline earth metallic salt and polyvinyl alcohol (PVA) to the base paper as shown in Table I. Thereafter, the base paper was subjected to calendering by passing the base paper through a calender machine so as to keep the front face on which a toner image receiving layer is formed in contact with a metallic calender roller at a surface temperature of 110° C. and the back face in contact with a metallic calender roller at a surface temperature of 40° C. The base paper was further subjected to soft calendering by passing the base paper through a soft calender machine so as to keep the front face in contact with a metallic calender roller at a surface temperature of 210° C. and the back face in contact with a metallic calender roller at a surface temperature of 40° C.

TABLE I

| | Metal salt | | PVA content | Density | Water content |
|---|---|---|---|---|---|
| | Type | Content: g/m² | g/m² | g/m³ | % |
| WE1 | CaCl₂ | 0.9 | 1.2 | 1.03 | 8.0 |
| WE2 | CaCl₂ | 1.5 | 1.2 | 1.01 | 7.0 |
| WE3 | NaCl₂ | 0.7 | 1.2 | 1.02 | 8.6 |
| WE4 | NaCl₂ | 2.0 | 1.2 | 1.05 | 8.5 |
| WE5 | CaCl₂ | 1.2 | 1.2 | 1.01 | 9.3 |
| WE6 | CaCl₂ | 3.8 | 1.2 | 1.03 | 7.9 |
| CE1 | CaCl₂ | 0.2 | 1.2 | 1.01 | 7.1 |
| CE2 | CaCl₂ | 0.7 | 1.2 | 1.03 | 3.6 |

| | | | | |
|---|---|---|---|---|
| CE3 | Non | 1.2 | 0.98 | 5.2 |

The base paper was provided with a polyethylene resin layer having a dry film thickness of 22 μm by means of fusion extrusion of a compound of polyethylene resin in a mixture ratio HDPE/LDPE by weight of 1:1 that contains 10% by weight of TiO₂ on the front surface thereof and a polyethylene resin layer having a dry film thickness of 20 μm by means of fusion extrusion of a compound of polyethylene resin in a mixture weight ratio HDPE/LDPE of 1:1 formed on the back surface thereof. Further, the base paper was subjected to corona discharge treatment and coated with 0.1 g/m² of gelatin on the front surface thereof and with 0.06 g/m² of gelatin and 0.02 g/m² of colloidal silica

<Preparation of Coating Liquid for Toner Image Receiving Layer>

(Titanium Dioxide Dispersion Liquid)

A titanium dioxide dispersion liquid was prepared by dispersing a mixture of the following components with NBK-2 manufactured by Nihon Seiki Co., Ltd.

| | |
|---|---|
| Titanium dioxide (Taipek RA-220: Ishiharasangyo Ltd.) | 40.0 g |
| PVA 102 | 2.0 g |
| Ion exchanged water | 58.0 g |

(Coating Liquid for Toner Image Receiving Layer)

A coating liquid for toner image receiving layer was prepared by mixing and stirring the following components.

| | | |
|---|---|---|
| Titanium dioxide dispersion liquid | 15.5 | g |
| Carnauba wax dispersion liquid | 15.0 | g |
| (Serzole 524: Chukyo Oils & Fats Co., Ltd.) | | |
| Polyester resin water dispersion liquid (solid content: 30%) | 100.0 | g |
| (KZA-7049: Unitika Ltd.) | | |
| Viscosity improver (Alcox E30: Meisei Chemical Co., Ltd.) | 2.0 | g |
| Anion surface active agent (AOT) | 0.5 | g |
| Ion exchanged water | 80 | ml |

The coating liquid for toner image receiving layer had the viscosity of 40 mPa.s and the surface tension of 34 mN/m. The polyester resin had a glass-transition temperature (Tg) of 61° C.

<Coating Liquid for Backing Layer>

A coating liquid for backing layer was prepared by mixing and stirring the following components.

| | | |
|---|---|---|
| Acrylic resin water dispersion liquid (solid part: 30%) | 100.0 | g |
| (Hyros XBH-997L: Seiko Chemical Indusiry Co., Ltd.) | | |
| Matting agent (Tekpomar MBX-12: Sekisui Chemical Co., | 5.0 | g |
| Ltd.) | | |
| Releasing agent (Hidrin D-337: Chukyo Oils & Fats Co.). | 10.0 | g |
| Viscosity improver (CMC) | 2.0 | g |
| Anion surface active agent (AOT) | 0.5 | g |
| Ion exchanged water | 80 | ml |

The coating liquid for backing layer had the viscosity of 35 mPa.s and the surface tension of 33 mN/m.

<Coating Toner Image Receiving Layer and Backing Layer>

Each of the working examples WE1-WE6 and comparative examples CE1-CE3 was coated with a backing layer on the back surface of the support with a bar coater and then with a toner image receiving layer on the front surface of the support with a bar coater. The spread of the backing layer was 9 g/m² by dry weight, and the spread of the image receiving layer was 12 g/m² by dry weight. The content of thermoplastic resin was 64% by weight with respect to the total weight of the toner image receiving layer. These toner image receiving layer and backing layer were subjected to on-line hot-air drying. Air flow and air temperature were adjusted so as to complete the drying of each layer within a period of two minutes after the application of coating. The drying temperature was set to a point at which the surface temperature of the coated layer becomes equal to the wet-bulb temperature of the hot-air. After drying, the support paper was further subjected to calendering by passing the support through a calender machine so as to keep the toner image receiving layer in contact with a metallic calender roller at a surface temperature of 55° C. under a nip pressure of 235 kN/m.

<Assessments>

Qualitative assessments were made on the basis of electrophotographic prints of a female portrait made by the electrophotographic printer shown in FIG. 1 using A-4 size electrophotographic image receiving sheets of the respective examples WE1-WE6 and CE1-CE3. The electrophotographic printer was equipped with a fixing belt comprising a polyimide film belt base having a width of 50 cm and a thickness of 80 μm and a releasing layer made of 50 μm fluorocarbon siloxane rubber film made by vulcanizing and hardening SIFEL610 (manufactured by Shinetsu Chemical Industry Co., Ltd.) that is one of precursors of fluorocarbon siloxane rubber. Cooling was performed at a feed speed of 53 cm/sec with a cooling device having a heat sink length of 80 mm.

<Measurement of Moisture Content of Base Paper>

The moisture content of the base paper of each of the examples WE1-WE6 and CE1-CE3 was weighed in terms of a loss of moisture of the base paper with the front and back polyethylene resin layers peeled off resulting from drying at 105° C. for four hours. The result is shown in Table 11. In this instance, although a slight loss of base paper fibers was caused by peeling the polyethylene resin layers off from the support, no significant difference in moisture content was proved.

<Feeding Property>

A feeding test was performed two times for each example by continuously printing 50 copies to assess the feeding property on the basis the number of jammed sheets or defective sheet feed such as double feed out of 100 prints. In this instance, one jamming or double feed was allowed as acceptable. The result is shown in Table II.

<Image Quality>

The electrophotographic prints were visually examined for comparative assessment in five grades, namely from A (excellent) to D (failure). In this instance, grades A and B were pegged as acceptable. The result is shown in Table II.

TABLE II

| | Moisture content % | Feeding property | Image quality |
|---|---|---|---|
| WE1 | 7.4 | 0 | A |
| WE2 | 6.6 | 0 | A |
| WE3 | 8.1 | 0 | A |
| WE4 | 8.0 | 0 | A |
| WE5 | 8.8 | 0 | B*¹ |
| WE6 | 7.5 | 0 | B*² |
| CE1 | 6.6 | 8 | A |
| CE2 | 3.2 | 11 | A |
| CE3 | 4.8 | 21 | A |

*¹There was a bit of spotty image quality due to undried indentations left during calendering
*²There was somewhat rough surface due to defective stability of a mixture liquid of PVA and CaCl₂,

As apparent from Table II, it is proved that the electrophotographic image receiving sheets of examples WE1-WE6 provide satisfactory image quality and encounter no failure in feeding and, on the other hand, that the electrophotographic image receiving sheets of examples CE1-CE3 are acceptable in light of image quality but encounter a frequent occurrence of failure in feeding.

As described above, the electrophotographic image receiving sheet of the present invention provides satisfactory image quality and has stable feeding property free from an occurrence of jamming and double feed.

While the invention has been described in detail in conjunction with specific embodiments thereof, it will be apparent to those skilled in the art that various other embodiments and variants can be made without departing from the spirit and scope of the invention.

What is claimed is:

1. An electrophotographic image receiving sheet comprising a support and a toner image receiving layer formed on at least one surface of the support said support comprising:
base paper; and
a polyolefin resin layer formed on each surface of said base paper;
wherein said base paper contains more than 0.5 g/m² of at least one of an alkali metal salt and an alkaline earth metal salt and a moisture content of 6.5% by weight or more.

2. An electrophotographic image receiving sheet as defined in claim 1, wherein said base paper contains said salt in a range of from 0.6 to 3 μm² and a moisture content in a range of from 6.5 to 8.5% by weight.

3. An electrophotographic image receiving sheet as defined in claim 1, wherein said salt comprises at least one member selected from the group consisting of alkali metal chloride, alkali metal carbonate, alkali metal sulfate, alkaline earth metal chloride, alkaline earth metal carbonate and alkaline earth metal sulfate.

4. An electrophotographic image receiving sheet as defined in claim 1, wherein said base paper contains a water soluble high molecular compound in a range of from 0.5 to 3 g/m².

5. An electrophotographic image receiving sheet as defined in claim 4, wherein said water soluble high molecular compound comprises at least one member selected from the group consisting of polyvinyl alcohol, carboxy-modified polyvinyl alcohol, carboxymethylcellulose, hydroxyethylcellulose, cellulose sulfate, polyethylene oxides and gelatin.

6. An electrophotographic image receiving sheet as defined in claim 1, wherein said base paper is prepared through surface sizing with solution containing at least one of an alkali metal salt and an alkaline earth metal salt, and a water soluble high molecular compound and subsequently calendaring.

7. An electrophotographic image receiving sheet as defined in claim 6, wherein said calendering is performed with a soft calender with a metal roller at a surface temperature of 150° C. or higher.

8. An electrophotographic image receiving sheet as defined in claim 1, wherein said base paper contains a sizing agent comprising at least one of an alkylketene dimer and an epoxidized fatty acid amide.

9. An electrophotographic image receiving sheet as defined in claim 1, wherein said base paper contains pulp fibers have a weight-average fiber length in a range of from 0.45 to 0.70 mm.

10. An image forming process for forming an image on an electrophotographic image receiving sheet comprising a support that comprises base paper and a polyolefin resin layer formed on each surface of said base paper, and a toner image receiving layer formed on at least one surface of the support, wherein said base paper contains more than 0.5 μm² of at least one of an alkali metal salt and an alkaline earth metal salt and a moisture content of 6.5% by weight or more, said image forming process comprising the steps of:
forming a toner image on said toner image receiving layer of said electrophotographic image receiving sheet;
heating and pressing said toner image receiving layer between a fixing roller and a fixing belt;
cooling said toner image receiving layer; and
removing said electrophotographic image receiving sheet from said fixing belt.

11. An image forming process as defined in claim 10, and further fixing said toner image on said toner imager receiving layer with a heat roller before said heating and pressing of said toner image receiving layer with said fixing roller and said fixing belt.

12. An image forming process as defined in claim 10, wherein said heating and pressing of said toner image receiving layer is performed by use of a fixing belt having either one of a layer of fluorocarbon siloxane rubber and a layer comprising an under layer of silicone rubber and an over layer of fluorocarbon siloxane rubber.

13. An image forming process as defined in claim 12, wherein said fluorocarbon siloxane rubber has at least one of a perfluoroalkyl ether group and a perfluoroalkyl group in a principal chain.
